(19) United States
(12) Patent Application Publication
(10) Pub. No.: US 2006/0014872 A1
(43) Pub. Date: Jan. 19, 2006

(54) Protective composition that allows in-situ generation of permeation channels therein

(76) Inventor: Roy W. Martin, Downers Grove, IL (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/147,499

(22) Filed: Jun. 7, 2005

Related U.S. Application Data
(63) Continuation-in-part of application No. 11/060,890, filed on Feb. 18, 2005.
Application No. 11/060,890 is a continuation-in-part of application No. 10/934,801, filed on Sep. 3, 2004.
(60) Provisional application No. 60/588,442, filed on Jul. 16, 2004.

(51) Int. Cl. C08K 5/05

(52) U.S. Cl. 524/386; 524/557

(57) ABSTRACT

A composition for controlling the release rate of an agent is presented. The composition includes a hydrophilic first component and a polymeric second component mixed with the hydrophilic first component. The composition remains substantially impermeable until exposure to a hydrophilic solvent that converts sites in the composition that are occupied by the hydrophilic first component to permeation channels for the hydrophilic solvent. The composition may be used for coating a core that contains an agent. When the composition is placed in the hydrophilic solvent, the hydrophilic solvent permeates to the core, dissolves the agent, and releases the agent at a controlled rate through the permeation channels. Where the core contains reactants for a target agent, the hydrohphilic solvent reaches the core and dissolves the reactants to trigger a chemical reaction that produces the target agent. The target agent is released at a controlled rate through the permeation channels.

### RELATED APPLICATIONS

This patent application is a Continuation-in-Part application of U.S. patent application Ser. No. 11/060,890 filed on Feb. 18, 2005, which is a Continuation-in-Part application of U.S. patent application Ser. No. 10/934,801 filed on Sep. 3, 2004, which in turn claims the benefit of U.S. Provisional Application Ser. No. 60/588,442 filed on Jul. 16, 2004 under 35 U.S.C. § 119(e). This application claims the benefit of all of the above patent applications and incorporates by reference the contents of all the above applications.

### FIELD OF INVENTION

This invention relates generally to an oxidizing compound and more particularly to an oxidizing compound that is stabilized for storage.

### BACKGROUND

Oxidizers are commonly used to effectively destroy organic and inorganic contaminants. Some of the typical applications of oxidizers include treatment of water systems and inactivation of bacteria and viruses in various media.

Although oxidizers are used in numerous applications, there are also applications where they are not used even though their utility is well established. The reason these oxidizers are not used often relates to their instability during storage. Oxidizers such as hypochlorous acid and peracids, for example, could be used in more applications than the disinfection applications that they are already used in if their stability can be improved. The problem with some of these powerful oxidizers such as hypochlorous acid and peracids is that their activity level tends to decrease during storage. Since the effectiveness of the oxidizers in various applications depends on their concentrations, activity levels, and the level of demand on the oxidizer as measured by its oxidation reduction potential (ORP), a reduction in the activity level of the oxidizers impedes their performance in the various applications. Thus, even if an oxidizer is initially highly effective, the effectiveness decreases during storage.

A few methods are currently used to get around this storage problem. One of these methods, which is the point-of-use generation method or the in-situ method, is desirable because it eliminates the need for prolonged storage. However, on a practical level, these point-of-use generation methods are not widely employed because they require expensive equipment and specialized expertise. Other in-situ generation methods involve adding the reagents to the water to produce the target agent. However, when doing this, significant dilution of reagents as well as competing reactions impede the level of conversion to the target agent.

Sometimes, the reagents are coated to provide a barrier between the reagents and the environmental elements, thereby making the reagents easier to store and use in formulations. The coatings are designed so that when they are combined with water, they dissolve and rapidly release the reagents. Silicates, for example, are widely used in laundry detergent applications. In the alkaline condition induced by the laundry formulation, the silicate coating rapidly dissociates and releases the encased additives into the bulk water. There are also instances where a highly hydrophobic coating such as a wax or slow-dissolving coating is used for time-release purposes. These cases operate on the basis of a mechanism similar to the mechanism of the silicate coating in that the outer coating material quickly dissolves to expose the enclosed material to the solvent in the environment, at which point chemical reaction starts.

Various bleaching and oxidizing compositions have been made to enhance the performance in an application. Such enhancement is desirable because the generally effective hydrogen peroxide donors such as percarbonate, perborate, and persulfate-based additives do not remove stubborn stains from clothing. To enhance their bleaching ability under the conditions that are typical to the application (e.g., laundry water), precursors are added to induce formation of a more effective bleaching agents (e.g., tetraacetyl-ethylenediamine (TAED)) in-situ. However, this addition of bleaching agent precursors has its disadvantages. For example, high concentrations of additives are needed to achieve effective results, increasing both the cost and inconvenience.

Another way of enhancing peroxygen compounds' performance is to make them more stable, thus allowing long-term storage. Sometimes, the peroxygen compounds and the formulations they are used in are coated to enhance storage stability. These coatings, however, do not always dissolve quickly and therefore increase the time it takes for the peroxygen compound to become effective. One of the ways to allow long-term storage of oxidizers such as potassium monopersulfate and chlorine is to store them in packages or bags. The packages or bags are designed to dissolve in water, so that they can be directly thrown into a body of water. Although the use of bags provides for easy application in large scale or macro applications, their utility is limited in that they can be used only for applications of a certain scale.

A method of stabilizing reactive components for storage without compromising or limiting their performance during usage is desired.

### SUMMARY

In one aspect, the invention is a composition for controlling a release rate of an agent. The composition includes a hydrophilic first component and a polymeric second component mixed with the hydrophilic first component. The composition remains substantially impermeable until exposure to a hydrophilic solvent that converts sites in the composition that are occupied by the hydrophilic first component to permeation channels for the hydrophilic solvent.

In another aspect, the invention is a composition for releasing an agent at a controlled rate. The composition includes a core containing an agent and a coating material deposited on the core. The coating material has a hydrophilic first component and a polymeric second component, and forms a barrier film for shielding the core from environmental elements. The hydrophilic first component forms permeation channels upon exposure to a hydrophilic solvent, the permeation channels allowing the hydrophilic solvent to reach the core.

In yet another aspect, the invention is a method of producing a composition for in-situ generation of a porous membrane. The method includes combining a hydrophilic first component, a preparation solvent, and a polymeric second component to prepare a liquid state mixture. The mixture is applied to a substrate, and the solvent is evaporated to produce a barrier coating on the substrate.

### BRIEF DESCRIPTION OF THE DRAWINGS

FIGS. 1A, 1B, and 1C are schematic illustrations of the reactor wall during a reaction.

FIGS. 2A, 2B, 2C, and 2D show different stages of a reactor undergoing a reaction.

FIG. 3 is a schematic illustration that the reactor of the invention may be used to form various target agents.

FIG. 4 shows the stability of PMPS in various alcohols which can be used to form suspensions or binders for formation of the core.

FIG. 5 shows the increase in viscosity provided by Carbopol® used to alter the rheology of the solution.

FIG. 6 demonstrates that a plurality of compositions may be agglomerated to form an agglomerate composition.

### DETAILED DESCRIPTION OF THE PREFERRED EMBODIMENT(S)

The invention is particularly applicable to generation and release of oxidizers that have bleaching, biocidal, or virucidal properties and it is in this context that the invention will be described. It will be appreciated, however, that the reactor, the method of making the reactor, and the method of using the reactor in accordance with the invention has greater utility and may be used for any other target agent(s). Although the main solvent is described as water for clarity of illustration, the invention is not so limited.

“Reactor space” is a space that is defined by the outline of a reactor, and includes the space surrounded by the reactor wall, the reactor wall itself, and any pores or channels in the reactor wall. A “main solvent,” which is described as a hydrophilic solvent (e.g., water) in this disclosure, may be any solvent that dissolves the agent/reactant(s) in the core. A substance that is released at a “controlled rate” is not released all at once but gradually over a period of time.

A “non-solvent” is a carrier and void producing volatile liquid in which the polymer or coating material used in forming the reactor wall is insoluble. The term is also used to describe a liquid in which the oxidizer and/or oxidizable substance is insoluble. A solvent and a non-solvent that are used together are miscible.

A “critical level” indicates that a predetermined amount of the target agent is generated by the chemical reaction in the reactor. The critical level may be, but does not have to be, defined by the pH level inside the reactor, the concentration of reactants inside the reactor, or the concentration of the target agent inside the reactor and the exact level varies depending on the types of reactants, the generated product, the reactor wall composition, outside environment, etc. When the reactor wall “disintegrates,” it could collapse due to a pressure difference between the inside and the outside of the reactor, dissolve in the main solvent, or come apart and dissipate due to forces applied by the movement in the main solvent. A membrane is a solid layer of material. A plasticizer is a compound that alters the pliability and/or the hygroscopicity of the polymer. A “surrogate” describes the various acid, salt, and derivative forms of a particular compound. “Water,” as used herein, is not limited to pure water but can be an aqueous solution.

The coating material described herein may be used to coat a desired agent to control the release rate of the desired agent in a main solvent. Alternatively, the coating material may be used to form a reactor wall by being deposited around reactants that produce a desired target agent. In both cases, the coating material controls the rate at which the main solvent reaches the agent or the reactants, and the rate at which the agent or the generated target agent is released.

This rate control function of the coating material makes the coating material effective for raising the yield of the target agent. To maximize the yield in a chemical reaction, it is usually preferable to start with high concentrations of reactants because the molar concentrations of the reactants determine the rate of reaction and the subsequent product yield. Therefore, adding reactants to a large body of water to be treated is not an effective way to generate the desired product in-situ. Adding the reactants to the water lowers the reactant concentrations, and the resulting conversion of the reactants to the desired product(s) is generally poor. Another factor to be considered is the side reactions. When generating an agent in-situ, the oxidizer reactant is often consumed in reactions other than those desired for the in-situ production of the target agent. Therefore, adding the reactants to the water to be treated results in more reagent requirements, longer reaction time, and/or an overall decreased yield of the target agent.

Furthermore, the chemical environment, such as pH, can adversely affect the in-situ production of the target agent. For example, reactions that are acid catalyzed are not supported in alkaline conditions such as laundry wash water. By isolating the reactants and controlling the conditions inside the reactor, efficient generation of the target agent(s) occurs regardless of the conditions external to the reactor.

When an oxidizer, such as potassium monopersulfate (PMPS), is added to water to convert sodium chloride to hypochlorous acid through a hypohalite reaction, the conversion or yield is dependent on the molar concentrations of the reactants. As described above, however, adding a given amount of reactants to a large volume of water yields poor conversion to the target agent. Furthermore, potassium monopersulfate is highly reactive with organic chemical oxygen demand (COD). Thus, upon being exposed to the bulk solution, the PMPS reacts with the COD and further reduces the concentration of PMPS that is available to induce the hypohalite reaction.

Where the coating material is used as a reactor wall, a high reaction yield can be maintained by controlling the rate at which the reactants are exposed to water. More specifically, if the reactants were first exposed to a small volume of water and allowed to react to generate the target agent, a high yield of the target agent can be obtained because the reactant concentrations will be high. Then, the target agent can be exposed to a larger volume of water without compromising the yield. The rate at which the reactants are exposed to water has to be such that the target agent is generated in high-yield before more water dilutes the reactants. The invention controls the reactants' exposure to water by coating the reactants with a material that allows water to seep in and reach the reactants at a controlled rate.

Depending on the embodiment, the agent or the target agent may be an oxidizer, a biocide, and/or a virucidal agent. The coating material may be made entirely of materials that are soluble in the main solvent, or may be made of a combination of soluble and insoluble materials. In the latter case, an undissolved shell would remain in the main solvent after all the agent or target agent is released.

Where the coating material is used as a reactor wall and is made entirely of materials that are soluble in the main solvent, the reactor may be referred to as a “soluble reactor” having walls that dissolve in the main solvent after the reaction has progressed beyond a certain point. The soluble reactor is stable when dry. When mixed with a main solvent (e.g., water), however, the coating material that forms the outer wall of the soluble reactor allows the solvent to slowly seep into the inside of the reactor and react with the core. The core of the soluble reactor contains one or more reactants that, when combined with the main solvent, react to generate a target agent. Since the concentrations of the reactants are high within the soluble reactor, a high yield of the target agent is achieved inside the reactor. After the generated amount of the target agent reaches a critical level and most of it is released, the coating material dissolves or dissipates.

In some embodiments, the composition of the invention has a diameter in the range of 10-2000 μm. However, the reactor is not limited to any size range. For example, the reactor may be large enough to be referred to as a “pouch.” A single reactor may be both a micro-reactor and a soluble reactor at the same time. Furthermore, a reactor may have multiple walls, e.g. a combination of a soluble wall and a non-soluble wall.

Where the coating material is used as the reactor wall, the core contains one or more reactants. For example, the core may contain an oxidizer reactant, an oxidizable reactant, or both. The reactor wall has a lower solubility than the reactants in the core or the target agent that is produced in the reactor. The reactor wall controls the diffusion of water into the reactor and restricts the diffusion of reaction components out of the reactor. The rate at which water seeps into the reactor and the rate at which the target agent leaves the reactor are controlled through the size and the number of the permeation channels in the reactor wall.

In one aspect, the composition of the invention includes a core and a coating material surrounding the core. If desired, additional layers may be formed for shielding the core from the environmental elements. However, one of the benefits of the coating material disclosed herein is that it acts as an environmentally protective layer on its own until the composition is placed in contact with the main solvent during use. Thus, an extra environmental protection layer is not necessary.

The invention includes a method of preparing the composition. The composition of the invention remains stable for storage but becomes “porous” upon contacting the main solvent.

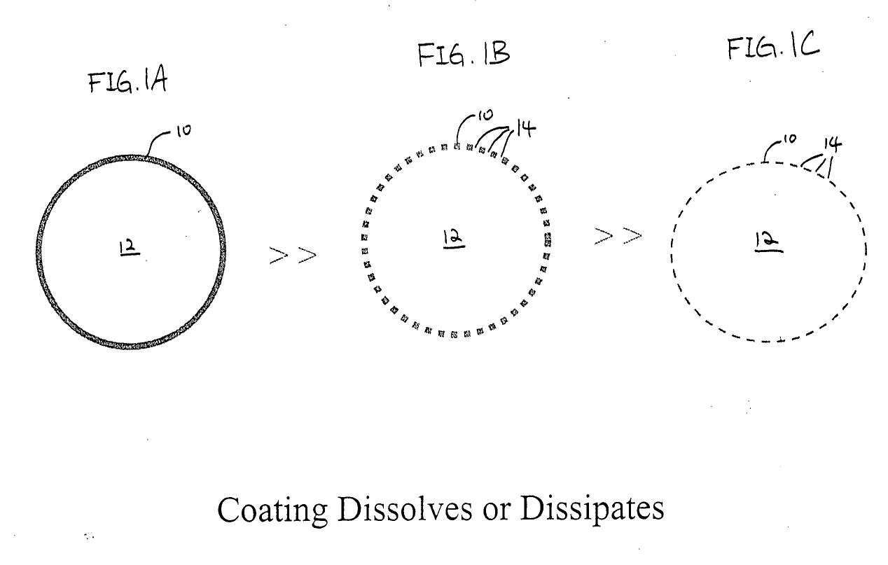

FIGS. 1A, 1B, and 1C are schematic illustrations of the coating material 10 of a composition 100. As shown in FIG. 1A, the coating material 10 is initially substantially solid, forming an enclosed space 12 where one or more agents/reactants (not shown) can be placed. When the coating material 10 encounters the main solvent, it slowly forms the permeation channels 14 in the coating material 10, as shown in FIG. 1B. The permeation channels 14 may be openings or pores, or a colloidal gel through which the main solvent can permeate. The size of a permeation channel typically ranges between about 2 nm and about 5 μm, and more typically between about 0.03 μm and about 1 μm. The main solvent seeps into the composition 100 through the permeation channels 14 and dissolves at least some of the core component in the enclosed space 12. Where the core contains the desired agent, the dissolved agent permeates out of the enclosed space 12 at a controlled rate through the permeation channels 14. On the other hand, where the core contains one or more reactants, the dissolving of the reactant(s) triggers a chemical reaction. The chemical reaction generates a target agent, which leaves the enclosed space 12 through the permeation channels 14 at a controlled rate.

When the permeation channels 14 form, the rest of the coating material 10 remains substantially intact. Preferably, the rest of the coating material 10 remains intact until the enclosed space 12 is substantially depleted of the agent or the target agent. Where the composition is used as a reactor, the parts of the coating material 10 that did not convert to permeation channels 14 remain substantially intact while the reactants react inside the enclosed space 12 to generate the target agent. This way, the chemical reaction takes place in a space that is substantially sheltered from the environment surrounding the composition 100. However, once the reaction has progressed to a critical level and substantially all of the target agent has left the enclosed space 12, the coating material 10 of this exemplary embodiment disintegrates, as illustrated in FIG. 1C by the thinning of the coating material 10. If the coating material 10 is made entirely of soluble materials, it eventually dissipates into the water.

Details about the composition of the coating material 10 are provided below.

One way to control the timing of the disintegration of the reactor wall is to select a coating material 10 whose solubility is a function of pH. In this case, the critical level is a certain pH level where the coating material 10 becomes soluble. If the solubility of the coating material 10 is impaired by the pH of the internal and/or the external solution, and the pH of the internal solution changes as the reaction in the enclosed space 12 progresses, the coating material 10 will not become soluble until a certain pH is reached in the reactor (i.e., the reaction has progressed to a certain point). The reactions may occur in the enclosed space 12 or along the inner surfaces of the coating material 10.

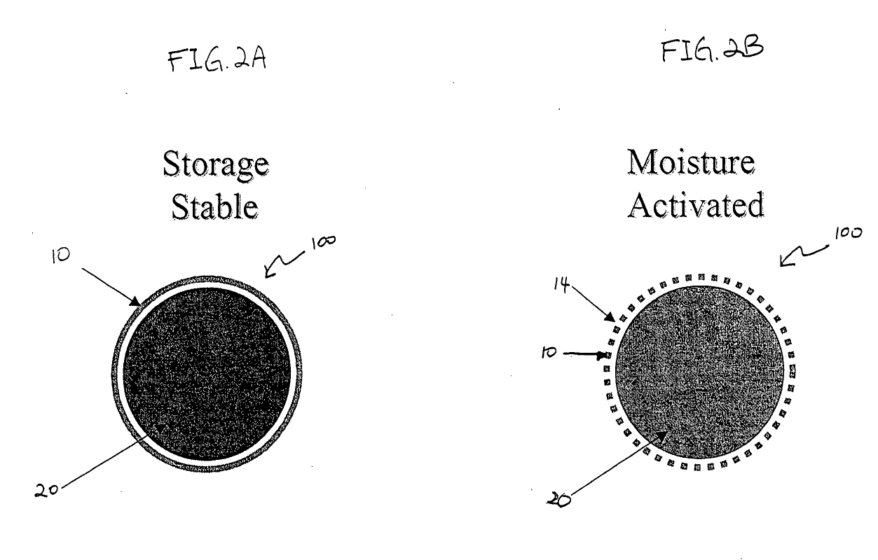

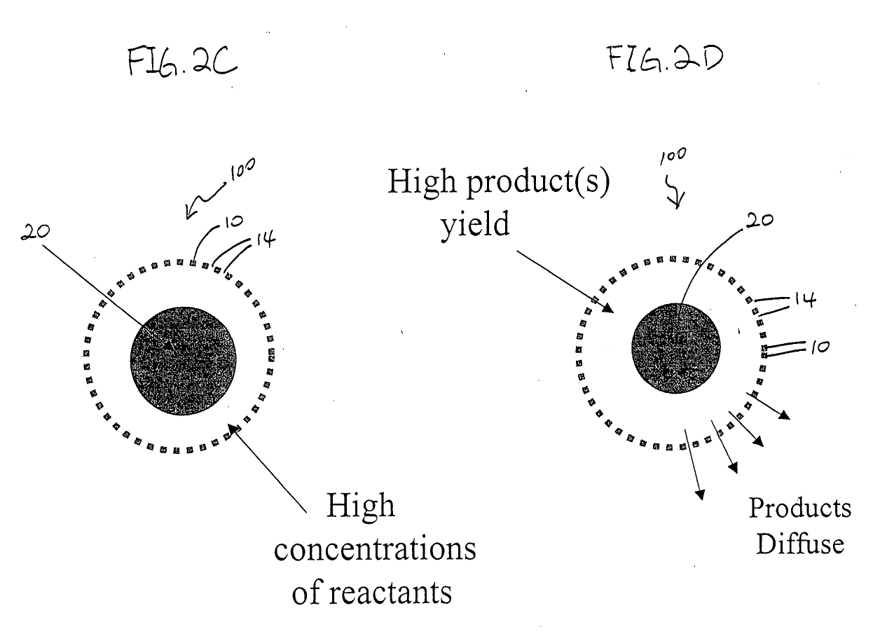

FIGS. 2A, 2B, 2C, and 2D show different stages of the composition 100 including a core 20. The core 20 is in the enclosed space 12. When in storage, the coating material 10 is intact and protects the core 20 from various environmental elements, as shown in FIG. 2A. When the composition 100 is placed in the liquid to be treated, the coating material 10 begins to form the permeation channels 14 and the core 20 begins to dissolve, as shown in FIG. 2B. Where the core 20 contains the desired agent, the dissolved agent permeates out of the enclosed space 12 through the permeation channels 14. As more of the agent dissolves and permeates out, the core shrinks (as shown in FIGS. 2C and 2D).

Where the core 20 contains one or more reactants, the reactants become reactive upon dissolving and a chemical reaction begins. Since the amount of the main solvent that permeates into the enclosed space 12 is small, the components that form the core 20 (i.e., the reactants in this case) remain high in concentration. As the chemical reaction progresses, the reactant concentration decreases, as shown by the decreasing size of the core 20 in FIG. 2C. The dissolved target agent leaves the enclosed space 12, and after the enclosed space 12 is sufficiently depleted, the coating material 10 begins to disintegrate if the coating material 10 is made of a material that is soluble in the main solvent. If, on the other hand, the coating material 10 contains material that is not soluble in the main solvent, the porous reactor wall remains as a shell. The total in-situ production of the target agent occurs in less than about 8 hours, preferably in less than about 2 hours and most preferably in less than about 1 hour.

The reactant in the core may contain an oxidizing agent, such as a peroxygen compound. The peroxygen compound may be, for example, monopersulfate, percarbonate, perborate, peroxyphthalate, sodium peroxide, calcium peroxide, magnesium peroxide, or urea peroxide. The oxidizing agent may also include a free halogen such as dichloroisocyanuric acid, a salt of dichloroisocynuric acid, a hydrated salt of dichloroisocyanuric acid, trichlorocyanuric acid, a salt of hypochlorous acid, bromochlorodimethylhydantoin and dibromodimethylhydantoin.

As for the “oxidizable reactant,” which may also be present in the core, it usually reacts with the oxidizer reactant to produce one or more target agents. The target agents may include an oxidizer that is different from the oxidizer reactant. In some embodiments, the oxidizable reactant is a catalyst that is not consumed during its reaction with the oxidizer reactant. However, in some other embodiments, the oxidizable reactant is altered and consumed by the reaction with the oxidizer reactant.

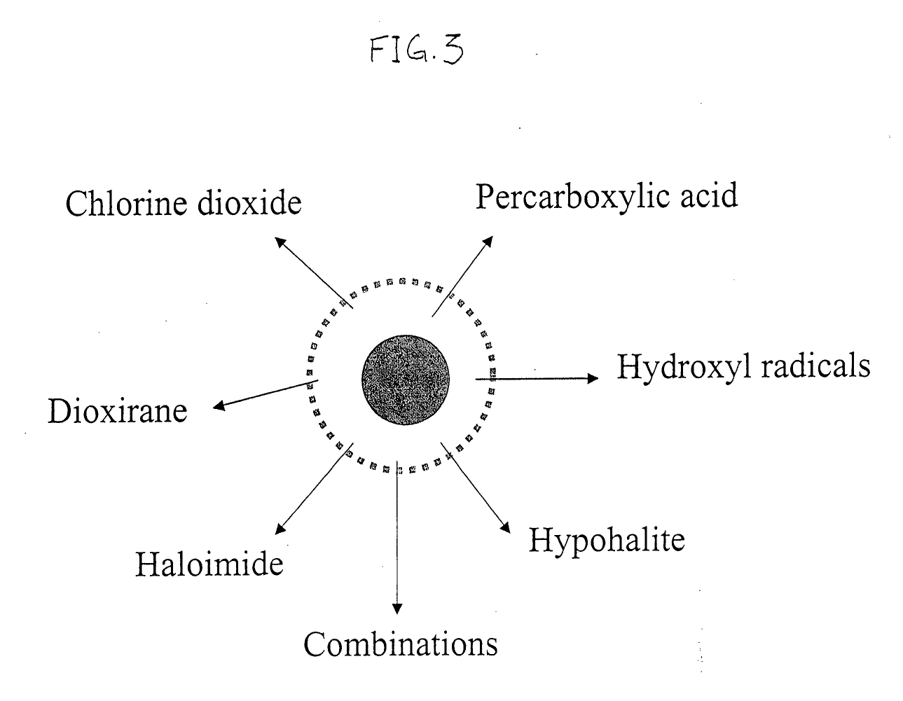

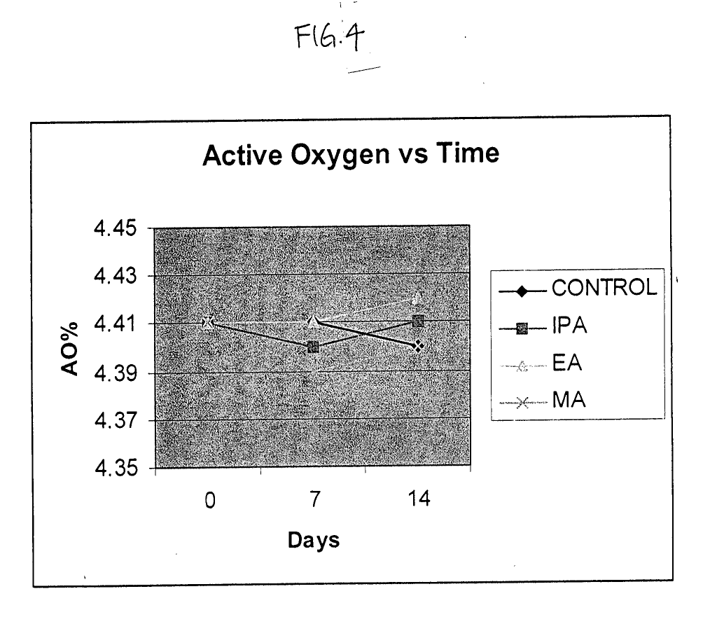

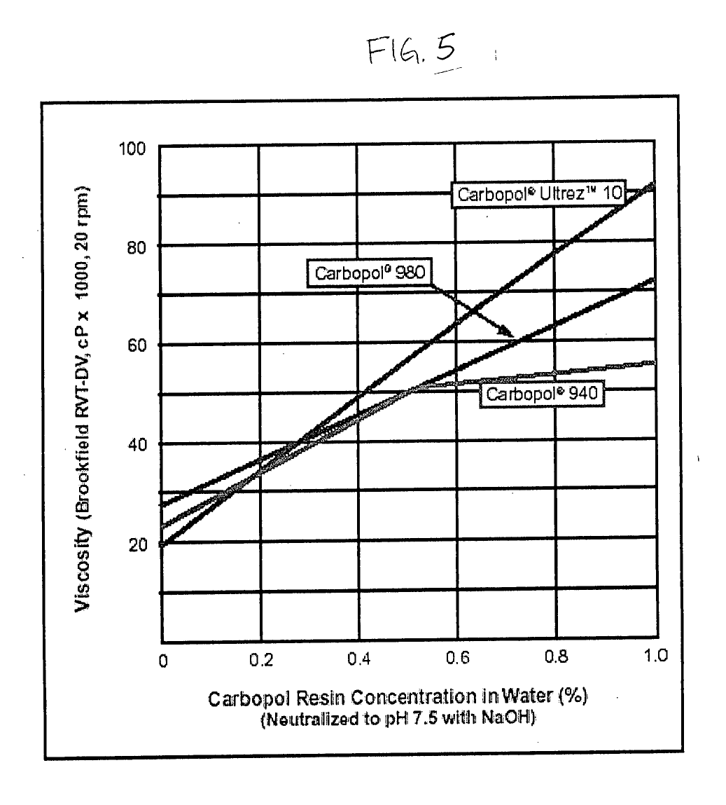

FIG. 3 is a schematic illustration that the composition 100 may be used to release a number of agents or target agents including but not limited to hypohalite, halo-amide, dioxirane, hydroxyl radicals, percarboxylic acids, or chlorine dioxide. The reactor is useful for producing one or more of hypochlorous acid, hypochlorite, chlorine gas, hypobromous acid, hypobromite, bromine gas, N-halo-succinimide, N-halo-sulfamate, N-bromo-sulfamate, dichloro-isocyanuric acid, trichloro-isocyanuric acid, 5,5 dihalo dialkyl hydantoin, hydroxyl radicals, oxygen radicals, peracids, and chlorine dioxide, and releasing the product into a body of water.

The Core

1) Agents/Reactants

As described above, the composition 100 may be used for releasing an agent at a controlled rate. An “agent” may be a reactant that is capable of generating a target agent (where a chemical reaction is involved) or the target agent itself (where no reaction is involved). A selected agent is prepared into the core 20 either by itself or with supplemental components (e.g., a binder) described below. The core 20 may contain, for example, single source oxidants such as a free halogen or a peroxygen compound, such as dichloroisocyanuric acid, trichloroisocyanuric acid, calcium hypochlorite, dibromodimethylhydantoin, bromochlorodimethyl hydantoin, lithium hypochlorite, percarbonate, perborate, persulfate, monopersulfate and the like. Any solid free halogen or peroxygen oxidizers can be effectively coated for storage and for controlled release of the agent during use. The composition 100 may be also be used for controlling the release of hygroscopic materials such as sodium bisulfate in high humidity environments.

Alternatively, the composition 100 may be used as a reactor for generating and releasing one or more target agents. In this case, the core contains reactants that are selected to induce the formation of the desired target agent(s). When determining the ratio of reactants, consideration should be given to the desired ratio of products. Single species generation of agent is achieved with proper optimization of reagent ratios.

High conversion of reactants and good stability of products are achieved by adding stabilizers and/or pH buffering agents to the mixture of reactants. For example, to produce N-haloimides such as N-chlorosuccinimide, N-succinimide is added to a mixture containing PMPS and NaCl. Also, an organic acid (e.g., succinic acid) and/or inorganic acids (e.g., monosodium phosphate) may be applied to ensure that the pH of the reactant solution is within the desired range for maximum conversion to the haloimide.

The core includes reactants that, upon dissolution, induce the in-situ generation of the desired target agent(s). For example, where the desired target agent is a bleaching/oxidation agent, the reactant may be a peroxygen compound such as a persulfate, inorganic peroxide, alkyl peroxide, and aryl peroxide, or a free halogen such as dichloroisocyanuric acid, a salt of dichloroisocyanuric acid, a hydrated salt of dichloroisocyanuric acid, trichlorocyanuric acid, a salt of hypochlorous acid, bromochlorodimethylhydantoin and dibromodimethylhydantoin. The core can be formed into any useful size and shape, including but not limited to a granule, nugget, wafer, disc, briquette, or puck. While the reactor is generally small in size (which is why it is also referred to as the micro-reactor), it is not limited to any size range.

Some references such as U.S. Pat. No. 6,605,304 disclose embedding the oxidizable reactant (e.g., a chlorite) in an inert material such as amorphous or crystalline silicate to avoid the oxidizable reactants from contacting one another. For example, in the case where the oxidizable reactant is a chlorite and the target agent is chlorine dioxide, not letting the chlorite anions touch one another avoids the formation of chlorate and chloride anions at high temperatures that reduces the chlorine dioxide generation. In the composition 100, such inert material is not necessary because the methods of production disclosed herein does not involve application of the high processing temperatures. Also, because the reactants needed to produce the oxidant are combined in the core, the composition 100 eliminates the need for a conduit that functions as a means of combining the reactants in chlorine dioxide generators such as the one described in U.S. Pat. No. 6,605,304. In the composition 100, different types of reactants in the core dissolve substantially simultaneously as they are contacted by water and react freely as liquid phase reactants in the space that is defined by the reactor wall.

2) Binders

Binders are compounds that are used to combine the components in the core and hold them together, at least until they are coated, to provide a homogeneous mixture of reactants throughout the core. Binders may not be necessary in some embodiments. Many different types of compounds can be used as binders including polymers with hydrophobic and/or hydrophilic properties (e.g. polyoxyethylene alcohol, fatty acid esters, polyvinyl alcohol,), fatty acids (e.g. myristic acid), alcohols (myristic alcohol), and polysaccharides such as chitosan, chitin, hydroxypropyl cellulose, hydroxypropyl methylcellulose and the like. The function of the binder is to provide an agglomerating effect without adding an undesirable amount of moisture so as to cause the reactants to dissociate and start reacting. In cases where solvent recovery apparatus is available during manufacturing, binder solvents can be used to promote better distribution of the binder as long as the solubility of the reactants in the binder solvent is low. Binders may constitute about 0.1-20 wt. % of the solvent-activated reactor.

Depending on the application and the other components that are involved, silicate, silica, clay minerals, zeolite, silicon dioxide, fumed silica, silicon oxyhydroxides, aluminum oxide, alumina gel, aluminum oxyhydroxides, aluminates, aluminum sulfate, polyaluminum chloride, metal oxides, metal oxyhydroxides, mineral salts, cross-linking agents, polysaccharides, or polymers may be used as the binder material.

The binder may be a rheology-altering polymer/copolymer such as Carbopol® sold by BFGoodrich that is a family of polymer/copolymers comprised of high molecular weight homo- and copolymers of acrylic acid crosslinked with a polyalkenyl polyether. Rheology-altering polymers allow a wide range of core components to be combined by incorporating a non-solvent in the core. Either the oxidizer reactant or the oxidizable reactant is insoluble in the non-solvent. The presence of the non-solvent prevents activation of the components in the core, whereby the rheology-altering component binds the core components to provide a homogenous mixture. Depending on the embodiment, the non-solvent may become a part of the final composition, be partially removed, or be removed altogether. Since the non-solvent is usually not water, the final product may contain volatiles although it is substantially free of water (moisture). Sometimes, moisture may be used to enhance the formation of the agglomerate. However, in such cases, at least the oxidizer reactant should be coated to prevent its dissociation, the moisture should be well-distributed and used sparingly, and any moisture should be completely removed before long-term storage.

3) Fillers

Fillers can be used or altogether omitted depending on the type of processing and the requirements of the use of the final product. Fillers are typically inorganic compounds such as various metal alkali salts and oxides, zeolites, clays, mineral salts, and the like. The fillers can enhance distribution of moisture when water is employed to enhance agglomeration.

4) pH Buffers

A pH buffer, which is an optional component of the core, provides a source of pH control within the reactor. Even when alkaline water from laundry wash is used to dissolve the core, the pH buffers provide effective adjustment and control of the pH within the desired range to induce the desired reactions inside the reactor. PH buffers can be inorganic (e.g. sodium bisulfate, sodium pyrosulfate, mono-, di-, tri-sodium phosphate, polyphosphates, sodium bicarbonate, sodium carbonate, boric acid, sulfamic acid and the like). Organic buffers are generally organic acids with 1-10 carbons such as succinic acid.

For the examples provided herein, the pH buffer is usually an alkali material.

5) Stabilizers

Stabilizers are added when N-hydrogen donors are applied to generate N-haloimides in-situ. Examples of stabilizers include but are not limited to N-succinimide, N-sulfamate, isocyanuric acid, hydantoin, and the like. When stabilization is not required to generate these compounds, they can be omitted.

6) Viscosity Modifier

Optionally, a viscosity modifier may be added to the core to control the viscosity within the core and reaction zone, thereby further restricting diffusion rate. Examples of viscosity modifiers are various polymers such as cross-linked polyacrylic acid sold under the trade name Carbopol® by Novean, copolymers such as poloxamers (e.g., Lutrol® sold by BASF), and polysaccharides such as xanthan gum.

7) Neutralizing Component

A neutralizing component is an alkali substance that increases the pH of the hydrophilic solvent when the solvent contacts the polymeric component. The resulting pH is preferably between 4.0 and 11.0. Although the neutralizing component may be incorporated into the core, it may also be combined with the polymeric component or added to the hydrophilic solvent as a mixture. The alkali substance that makes up the neutralizing component may be a bicarbonate, carbonate, hydroxide, silicate, phosphate, borate, or sulfate.

8) Reactor Examples

Where the target agent is dioxirane, the oxidizer reactant is one of potassium persulfate, sodium persulfate, ammonium persulfate, potassium monopersulfate, permanganate, and a Caro's acid precursor. The Caro's acid precursor is a combination of a peroxide donor (e.g., urea peroxide, calcium peroxide, magnesium peroxide, sodium peroxide, potassium peroxide, perborate, perphosphate, persilicate, and percarbonate) and a sulfuric acid donor (e.g., sodium bisulfate and pyrosulfate and a sulfuric acid donor). In addition to the oxidizer reactant, the core may also include an organic compound containing carbonyl groups (C═O) to produce dioxirane. Preferably, the organic compound has 3-20 carbons. The core composition may be 10-80 wt. % oxidant and 0.5-50 wt. % carbonyl donor such as aldehydes, ketones, and carboxylic acids. If a binder or a filler is used, each of these components does not make up more than 50 wt. % of the core. If a pH buffer is used, it does not exceed 30 wt. % of the pH buffer. Dioxirane formation is typically most efficient around neutral pH.

Where the target agent is a peracid, for example peroxycarboxylic acid (also referred to as percarboxylic acid), it can be produced with a core that includes an oxidizer reactant such as urea peroxide, calcium peroxide, magnesium peroxide, sodium percarbonate, sodium perborate, persulfate(s), monopersulfate, persilicate, perphosphate, sodium peroxide, lithium peroxide, potassium peroxide, or permanganate. The core may also include a carboxylic acid donor such as an ester or acetic acid in the form of an anhydride (e.g., acetic anhydride). Another example is inclusion of tetraacetyl-ethylenediamine (TAED) with the peroxide donor for production of peracid in alkaline conditions. The peracid can be a percarboxylic acid but may also include perhydroxyl (HOO⁻). The core composition is about 10-80 wt. % oxidizer reactant and about 1-40 wt. % carboxyl group donor. Optionally, a binder, a filler, and a pH buffer may be added to the core. The core is at least 50 wt. % solids. The molar ratios are optimized and addition of pH buffers is employed in the core composition before coating. Upon dilution with water, the core dissolves and produces a ready source of peracetic acid in high yield.

Where the target agent is a hypohalite, the reactant in the core may be potassium persulfate, sodium persulfate, ammonium persulfate, potassium monopersulfate, permanganate, or a Caro's acid precursor. The Caro's acid precursor is a combination of a peroxide donor (urea peroxide, calcium peroxide, magnesium peroxide, sodium peroxide, potassium peroxide, perborate, perphosphate, persilicate, and percarbonate) and a sulfuric acid donor (sodium bisulfate and pyrosulfate). The core is about 10-80 wt. % oxidizer reactant and about 0.5-40 wt. % halogen donor. Optionally, a binder, a filler, and a pH buffer may be added to the core.

Where the target agent is an N-halo-amide, the reactant may be a potassium persulfate, sodium persulfate, ammonium persulfate, potassium monopersulfate, permanganate, or a Caro's acid precursor. The core may also include a monovalent metal salt, a divalent metal salt, or a trivalent metal salt, as well as an N-hydrogen donor capable of reacting with hypo-halite to generate the target agent and a halogen donor such as a chloride or bromide donor. The composition of the core is about 10-80 wt. % reactant, 0.5-40 wt. % a halogen donor, and 2-50 wt. % stabilizer. Optionally, a binder, a filler, and a pH buffer may be added to the core.

Where the target agent is chlorine dioxide, the core composition is about 10-95 wt. % reactant, about 0-20 wt. % halogen donor, and about 0.5-60 wt. % chlorite donor. In one embodiment, the reactant in the core may be potassium persulfate, sodium persulfate, ammonium persulfate, potassium monopersulfate, permanganate, or a Caro's acid precursor. The halogen donor may be, for example, a mono-valent or di-valent metal salt including but not limited to magnesium chloride, calcium chloride, sodium chloride, or potassium chloride. The halogen donor may be part of the chlorite donor, which may be sodium chlorite, potassium chlorite, magnesium chlorite, or calcium chlorite, or various combinations thereof.

In another variation where the product is chlorine dioxide, the core composition is about 10-95 wt. % reactant (e.g., an acid source), about 0.5-40 wt. % free halogen donor, and about 1-50 wt. % metal chlorite. The reactant may be potassium monopersulfate, a metal bisulfate (e.g., sodium bisulfate), a metal pyrosulfate, or a metal phosphate. The free halogen may be selected from at least one of: dichloroisocyanuric acid, a salt of dichloroisocyanuric acid (e.g., a sodium salt thereof), a hydrated salt of dichloroisocyanuric acid, trichlorocyanuric acid, a salt of hypochlorous acid, bromochlorodimethylhydantoin, or dibromodimethylhydantoin may be used as the free halogen donor. A sodium salt of dichloroisocyanuric acid dihydrate may also be used. The chlorite may be a mono- or di-valent chlorite such as sodium or calcium chlorite.

An example of a chlorine dioxide generator contains sodium chlorite, sodium bisulfate, and the sodium salt of dichloroisocyanuric acid dihydrate in the core.

Where the core includes a metal chlorite, an acid source, and a free halogen donor, the chemical reaction that occurs when the main solvent reaches the core generates an oxidizing solution containing chlorine dioxide and free halogen. The concentration of the free halogen in the oxidizing solution is less than ½ of the chlorine dioxide concentration in the oxidizing solution, preferably less than ¼ of the chlorine dioxide concentration in the oxidizing solution, and more preferably less than 1/10 of the chlorine dioxide concentration in the oxidizing solution. The ratio of the chlorine dioxide concentration to the sum of the chlorine dioxide concentration and chlorite anion concentration in such solution is at least 0.25:1, preferably at least 0.6:1, and more preferably at least 0.75:1 by weight. In some embodiments with a high free halogen content, the free halogen concentration in the oxidizing solution may be as high as 100 times the chlorine dioxide concentration. The ratio of the chlorine dioxide concentration to the sum of the chlorine dioxide concentration and chlorite anion concentration in such solution is at least 0.5:1 by weight.

Chlorine dioxide may also be produced by including a metal chlorate and an acid source in the core. The metal chlorate may be sodium chlorate, and the acid source may be sodium persulfate, potassium persulfate, or potassium monopersulfate. A filler (e.g., mineral salts, clays, zeolites, silicate, silica) may be added to the core if desired.

In another embodiment, the reactant is urea peroxide, calcium peroxide, magnesium peroxide, sodium percarbonate sodium perborate, persulfate(s), monopersulfate, persilicate, perphosphate, sodium, lithium, or potassium peroxide. A chlorate donor such as sodium chlorate, potassium chlorate, lithium chlorate, magnesium chlorate, and calcium chlorate may be included in the core.

Where the target agent is a hydroxyl radical, the core composition may be about 10-80 wt. % reactant, about 0.001-20 wt. % a transition metal, and about 1-50 wt. % pH buffer. In addition, a binder and a filler may be used. However, each of the binder and the filler is preferably not present in an amount exceeding 50 wt. % of the core. The reactor in the core may be urea peroxide, calcium peroxide, magnesium peroxide, sodium percarbonate sodium perborate, persulfate(s), monopersulfate, persilicate, perphosphate, sodium, lithium, permanganate, or potassium peroxide. The transition metal may include a chelating agent selected from a group consisting of trisodium pyrophosphate, tetrasodium diphosphate, sodium hexametaphosphate, sodium trimetaphosphate, sodium tripolyphosphate, potassium tripolyphosphate, phosphonic acid, di-phosphonic acid compound, tri-phosphonic acid compound, a salt of a phosphonic acid compound, ethylene diamine-tetra-acetic acid, gluconate, or another ligand-forming compound.

Hydroxyl radical may be produced with a reactor that contains a metal catalyst. The metal catalyst may be contained in the core, coated on the core, or included in the reactor wall, for example in the pores on the membrane. The metal catalyst may be Cu (II), Mn (II), Co (II), Fe (II), Fe (III), Ni (II), Ti (IV), Mo (V), Mo (VI), W (VI), Ru (III), or Ru (IV). Upon dilution with water the composition releases peroxide. Under neutral to acidic conditions is converted to hydroxyl radicals upon reaction with the catalyst. The catalyst remains unaltered.

Where the target agent is a singlet oxygen, peroxide salts such as calcium, magnesium, sodium peroxides, perborate, or percarbonate, may be used as the reactant with a metal catalyst selected from transitional metals.

9) Core Configurations

Generally, the core composition is broken down to about 1-90 wt. % oxidizer reactant and about 1-50 wt. % oxidizable reactant, although there may be exceptions, as described above. Preferably, the oxidizable reactant is about 10-50 wt. % of the core.

There are different configurations in which the core can be prepared, depending on the types of equipment available, the core composition, and the solubility characteristics of the core components.

A first configuration is a layered configuration wherein the different components form discrete layers. In this configuration, the oxidizable reactant is separated from the oxidizer reactant by a layer of a third component. This can be accomplished, for example, by spray coating or adding components in separate mixing stages, such as in a fluidized bed drier, to produce separate layers. When using this method, controlled diffusion rates through the reactor coating is achieved to ensure that adequate reaction internal to the reactor happens prior to diffusion of the target agent(s). The diffusion rates can be further controlled by arranging the layers such that the most soluble component makes up the innermost layer of the core.

A second configuration is a homogeneous core. In this configuration, the core components and the binder are combined and mixed to form a homogenous core. The binder can be any one or more of the compounds mentioned above, and one or both of the oxidizer reactant and the oxidizable reactant are immiscible with the binder. The mixing can be carried out in a blender/mixer, agglomerator, or a fluidized bed device. If there is moisture in the core, it can be dried to remove any final moisture. If non-solvents are used to enhance agglomeration, moisture is removed even if other residual volatiles may remain. Alcohols, for example, which are compatible with potassium monopersulfate and can be formed into a gel or virtual solid by adding rheology modifiers like Carbopol®, may remain. Thus, although there may be volatile components in the final composition, the core is substantially free of moisture. Any reference to “drying” during processing the reactor refers to the removal of water, and does not necessarily imply that all volatiles are removed.

The descriptions of various components and examples of said components are not meant to limit the invention. Other unspecified compounds that perform the same function are considered within the scope of the invention.

10) Producing the Core for Solvent Activated Reactor

The core is first produced by using any or a combination of suitable conventional equipment and techniques. Regardless of the equipment or technique, an effective amount of reactants are distributed within the reactor core. The term “effective distribution” is defined by the core's ability to generate the target agent(s) when exposed to water. The components comprising the core can be fed into a mixer/densifier using high, moderate or low shear such as those sold under the trade names “LÖdige CB30” or “LÖdige CB30 Recycler,” a granulator such as those sold under the trade names “Shugi Granulator” and “Drais K-TTP 80”. In some cases, a binder can be combined to enhance core formation. The core components can also be fed into the mixer or agglomerator at separate stages as to form layers thereby separating the oxidizer reactant from the oxidizable reactant. This is relevant when moisture addition is involved in the processing. However, when solvents or binders are used in which at least one of the oxidizer reactant and the oxidizable reactant are immiscible, the core components can be combined in one single stage or in multiple stages.

The core can be formed by directly feeding the reactants into the agglomerating equipment. Once fed to the device, a pressure ranging from about 1,000 to about 10,000 psig is applied. The actual pressure is determined based on the final composition, the desired density of the resulting agglomerate composition, the desired dissolution rates, and the like. The resulting high density agglomerate composition can be crushed or ground to produce cores having a specific particle size.

Examples of equipment suitable for producing the massive body include: compactor, agglomerator, roll compaction, briquetting/tableting and the like. Some of these suitable equipment are obtainable from Hosokawa Micron Corporation.

Furthermore, a spray-drying tower can be used to form a granular core by passing a slurry of components through the spray drier. The reactants and other components that make up the core are fed as a slurry to a fluidized bed or a moving bed drier, such as those sold under the trade name “Escher Wyss.” When using a fluidized bed or a moving bed drier, care must be taken to consider the solubility and reactivity of the components in the core. For example, a halide donor combined directly to the PMPS in a moist environment will give off chlorine gas. To prevent this chlorine emission, the PMPS may first be coated to prevent direct contact between the halide and moisture. Alternatively, an intermediate solvent may be used to shield the PMPS from the moisture. The intermediate solvent is selected such that either the coated PMPS or the halide salt is insoluble or have poor solubility (i.e., alcohols). A binder that is un-reactive with the oxidizer reactant can be combined into the core either before or during the spray drying or spray graining process to enhance agglomeration without compromising oxidizer activity.

In another aspect of the invention, the core components are combined in an alcohol solution that is thickened with a rheology modifier, and then dried in a spray drier, fluidized drier, or the like. This alcoholic gel improves the long-term storability of reactants such as PMPS by further preventing the reactants from coming into contact with water. More details about the alcoholic gel is provided in a copending U.S. patent application Ser. No. 10/913,976 filed on Aug. 6, 2004, which is entitled “Storing a Composition in an Alcoholic Gel.” The combining of the reactant components may be done in-situ during the fluidizing process. Alternatively, the components may be combined externally in a granulator, densifier, agglomerator, or the like prior to the fluidizing process.

Spray graining layers of core components is another way of preventing direct contact between the oxidizer reactant and precursors such as halides that may induce the production of halogen gas. This method is useful when membrane-based coatings are applied as described herein. The membrane-based coating sufficiently suppresses diffusion of the dissolved components through the pores due to osmotic pressure. Molecular diffusion is sufficiently slow to allow for the reactants to dissolve and react prior to diffusion of the produced agent(s).

The oxidizer reactant of the core can be coated with an aqueous solution or slurry of the components that make up the remainder of the core while suspended in a fluidized drier system. The resulting core composition can be either dried and removed from this stage of the process, agglomerated while in the fluidized bed drier, or removed and further mixed using equipment such as the mixer/densifier discussed above.

To further enhance the processing options and maintain the activity of the oxidizer reactant, the oxidizer reactant may be coated independently of other core components to enhance its processing survivability. The coating material may include inorganic as well as organic materials such as alkali metal salts, polysaccharides, etc. The coating must have sufficient solubility when exposed to the environmental conditions inside the reactor. For example, alkali metals salts such as magnesium carbonate function as anti-caking agents for PMPS and enhance the oxidizer's processing survivability. However, when exposed to an acidic environment, the alkali rapidly dissolves, exposing the PMPS. Chitosan is another example of a coating that improves the product's process survivability and hygroscopicity. Under normal storage conditions, when exposed to acidic conditions and in particular organic acids, the polymer becomes very hydrophilic and rapidly dissolves exposing the PMPS. This condition can be exploited by including organic acid donors such as succinic acid into the core composition when using chitosan-coated PMPS.

Multiple oxidizers can be generated by altering the ratio of core components. Combining reactants to produce N-chlorosuccinimide, hypochlorous acid, and chlorine dioxide can provide synergistic effects from one product by using multiple mechanisms of oxidation.

Examples of oxidizable reactants consumed or altered in the reaction with the oxidizer include but are not limited to: halogen donors such as NaCl and NaBr, organic carboxylic acids having from 1-10 carbons and at least 1-carboxylic acid (COO—) group such as citric acid or acetic acid donors, ketones, and aldehydes. Examples of oxidizable substances not consumed or altered in the reaction are: transition metal donors such as iron or copper salts or bound by chelants.

Coating Material

After the agents/reactants are selected, the coating material for encapsulating the reactants is selected. With proper selection of coating material based on its solubility in the main solvent, the main solvent permeates through the coating material and dissolves the agents/reactants in the core. The solubility of the polymeric component in the coating material is preferably lower than the solubility of the agents/reactants or the target agent, so that the solution in the reactor space is released at a controlled rate through the permeation channels. At the same time, the reactants are contained within the walls of the coating material and not allowed to diffuse out through the coating until the reaction has progressed beyond a critical point.

By restricting the diffusion of reactants, their respective molar concentrations inside the coating remain high, increasing the yield of the agents. The coating material may include silicate, cellulose, chitin, chitosan, polymaleic acid, polyacrylic acid, polyacrylamides, polyvinyl alcohols, polyethylene glycols, and their respective surrogates. This is an exemplary list and is not intended to be exhaustive.

The permeation channels (e.g., colloidal gel or pores) allow the dissolved agent or the target agent to migrate out of the reactor. The target agent may be dissolved in the main solvent to form an oxidizing solution. Initially, osmotic pressure on the coating material increases, thereby squeezing in the main solvent into the reactor. A controlled permeation of the dissolved agent or the target agent from the inside of the reactor occurs to prevent the reactor wall from rupturing. Where there is a chemical reaction in the enclosed space, this permeation is enhanced by the gas(es) often produced during the chemical reaction. The rate of permeation both into and out of the reactor is controlled by the size and the number of the permeation channels in the coating material.

Two properties that are desirable in the coating material are: 1) it allows for adequate permeation of water to dissolve the reactants in the core, thereby triggering a chemical reaction inside the reactor, and 2) it acts as a barrier for preventing the agent or the target agent from diffusing out to the water body all at once, forcing a controlled release instead. Both of these properties depend on the solubility of the coating material, which in turn may depend on the surrounding conditions (e.g., pH, solvent type). Thus, the surrounding conditions should be taken into consideration when choosing the coating material.

1) Silicate-Based Coating Material

Examples of coating material include silicates, silicones, polysiloxane, and polysaccharides including chitosan and chitin. The silicate-based coating material may be something that contains silicate, such as metasilicate, borosilicate, and alkyl silicate.

How suitable a particular coating material is for a given application depends on the surrounding conditions. For example, silicate coatings are well established for providing a barrier film of protection to percarbonates and other bleaching agents used in laundry detergents but do not always make a reactor. In laundry detergents, the inclusion of bleach precursors such as tetraacetyl-ethylenediamine or nonanoyl-oxybenzene sulfonate to enhance the bleaching performance in low temperatures is common. The hydrolysis of the precursors requires alkaline pH conditions. In such applications, due to the hydrolysis requirements and peroxygen chemistry, the internal and external solution used to dissolve the reactants is high in pH. The silicate coating is soluble under alkaline conditions, and the integrity of the reactor wall is compromised. The coating dissociates rapidly, without controlling the release rate. In this case, the benefit of the high reaction yield is not achieved.

Silicates provide for a simple and inexpensive reactor coating when used in lower pH applications or formulations that result in internal acidic pH conditions that sustain the integrity of the reactor wall. This usefulness of silicates remains uncompromised even if the external conditions are alkaline in pH, such as in the case of laundry water. Silica solubility is poor at low pH. At lower pH, silica remains colloidal and forms a colloidal gel. When monopersulfate (MPS) and a source of chloride such as NaCl are encased within a coating of silicate such as sodium silicate, then added to water, the water permeates through the permeation channels in the coating and dissolves the core. The resulting low pH (<5) from the dissolving MPS suppresses the dissolution rate of the surrounding silica, and the silica remains as a colloidal gel.

Inside the space enclosed by the silica gel coating, the concentration of reactants remains high and the resulting reactions produce high yields of chlorine gas. Upon diffusion of the reactants and the chlorine into the surrounding water, hypochlorous acid and hypochlorite ions form as a function of the water's pH. The resulting conversion to the target agent is therefore much higher when the pH inside the reactor is low and the reactor wall remains undissolved. With the inclusion of N-succinimide, it is now possible to produce N-chlorosuccinimide with the slow-diffusing chlorine gas. pH buffers can be added to further ensure efficacy based on application requirements. In alkaline pH conditions such as laundry bleaching, the elevated pH will not allow for generation of the N-chlorosuccinimide. By sustaining the integrity of the reactor, the internal conditions of the reactor are such that the reactions are successfully carried out. The target agent is efficiently generated and released.

2) Polymer Surfactant Coating Material

In some embodiments, the reactor wall is made of a generally hydrophobic substance that includes hydrophilic constituents. A mixture of hydrophobic and hydrophilic substance is applied to the core and dried. Upon addition of water, the hydrophilic component dissolves and the hydrophobic polymer remains intact, forming a porous shell around the core. Water permeates through the pores to reach the core and trigger a chemical reaction. Then, eventually, after the critical level is reached, the hydrophobic substance disintegrates. More details about this coating process are provided below.

Applications where alkaline pH aquatic conditions are achieved or increased control of diffusion rates is desired can utilize hydrophobic coatings combined with hydrophilic agents. This hydrophobic coating material may be useful with an alkaline-pH aquatic environment where the silicate coating is ineffective as a reactor. As mentioned above, hydrophobic coatings may possess hydrophilic portions, such as some hydrophilic functional groups inherent in the polymer structure. However, the hydrophobic coatings have a hydrophobic backbone that limits their solubility substantially, thereby allowing them to effectively function as a reactor by maintaining the integrity of the reactor walls until the reaction inside has progressed beyond a critical point. This critical point may be defined by a condition such as the pH of the solution inside the reactor or the concentration of the target agent.

Examples of hydrophobic polymers include but are not limited to polyoxyethylene alcohols such as R(OCH₂CH₂)ₙOH, CH₃(CH₂)ₘ(OCH₂CH₂)ₙOH, and polyoxyethylene fatty acid esters having the general formula RCOO(CH₂CH₂O)ₙH, RCOO(CH₂CH₂O)ₙOCR, oxirane polymers, polyethylene terephthalates, polyacrylamides, polyurethane, latex, epoxy, and vinyl, cellulose acetate. Suitable hydrophilic components include but are not limited to: polycarboxylic acids such as polymaleic acid, polyacrylic acid, and nonionic and anionic surfactants such as ethoxylated or sulfonated alkyl and aryl compounds.

The non-solvent is generally hydrophilic and is removed after the application of the coating to leave voids and channels. The amphipathic agent is used to combine the polymer coating with the hydrophilic non-solvent. The resulting coat is usually micro-porous but the process may be altered to form macro-porous voids and channels. The ratio of solvent to non-solvent as well as non-solvent selection can be adjusted to provide varying degrees of pore size, distribution, and symmetry.

Polysiloxane emulsified in water using water-soluble surfactants provides for an effective coating in pH-sensitive applications. The emulsion is applied to the composition's core (i.e., to the reactants) and then dried, as is performed in the application of the silicates. However, when exposed to water, the hydrophilic component dissociates, forming pores in the hydrophobic polysiloxane coating. The water then permeates into the reactor dissolving the core and activating the reactants. The reactions produce the desired target agents in high yield, and these target agents act on the bulk body of water when the reactor wall dissolves. Due to the high chemical stability of the polysiloxane, the integrity of the reactor coating remains uncompromised in alkaline pH conditions.

Another version of this method is to combine a non-ionic waxy surfactant with the solvent, wherein the surfactant acts as the non-solvent. A polymer such as cellulose triacetate is dissolved in the solvent that is mixed with the surfactant, and resulting solution is applied to the core. The solvent is evaporated, leaving behind the non-solvent that carries the polymer. Upon contact with water, the non-solvent dissolves and leaves behind the water-insoluble polymer, thereby forming pores in the polymer coating.

Yet another version of this method is to combine a mineral salt in a solvent such as 1,3-Dioxolane, dissolve a polymer such as polyester in the solvent, and apply the resulting solution to the core. Upon exposure to water, the mineral salts dissolve, leaving voids in their place.

3) Membrane

In another embodiment, the reactor wall 10 is a hydrophobic and porous membrane. A second coating can be applied to improve the shelf life in high-humidity storage conditions. To further improve on the diffusion rates by providing for a controlled porosity and pore symmetry, the hydrophobic components such as cellulose acetate can be dissolved in a solvent and combined with a non-solvent that is amphipathic or has a hydrophilic functionality. After forming the coating, both the solvent and non-solvent are removed (e.g., evaporated) leaving a coat with a specific porosity. The porosity can be altered by controlling the ratio and types of non-solvent and solvent to the hydrophobic component. For example, addition of ethanol into a mixture of acetone/water-magnesium perchlorate (solvent/non-solvent mixture) produces asymmetrical pores. “Solvents” have the ability to dissolve the hydrophobic polymer while being soluble in the non-solvent.

In some embodiments, the non-solvent can be a gas such as air that is entrained in the solvent-polymer mixture. This entrained air can be achieved by producing a foam using established farm generating techniques. Upon contact with the core, the foam collapses while evaporation forms the polymer coating. The entrapped air is released, leaving behind pores and channels.

The hydrophobic component can be any number of thermoplastics and fiber forming polymers or polymer precursors, including but not limited to polyvinyl chloride, polyacrylonitrile, polycarbonate, polysulfone, cellulose acetates, polyethylene terephthalates, and a wide variety of aliphatic and aromatic polyamides, and polysiloxane. Using this coating technology, a membrane with controlled porosity is produced. Representative synthetic polymers include polyphosphazines, poly(vinyl alcohols), polyamides, polycarbonates, polyalkylenes, polyacrylamides, polyalkylene glycols, polyalkylene oxides, polyalkylene terephthalates, polyvinyl ethers, polyvinyl esters, polyvinyl halides, polyvinylpyrrolidone, polyglycolides, polysiloxanes, polyurethanes and copolymers thereof. Other suitable polymers include, but are not limited to, methyl cellulose, ethyl cellulose, hydroxypropyl cellulose, hydroxypropyl methyl cellulose, hydroxybutyl methyl cellulose, cellulose acetate, cellulose propionate, cellulose acetate butyrate, cellulose acetate phthalate, carboxymethyl cellulose, cellulose triacetate, cellulose sulfate sodium salt, poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate), poly(octadecyl acrylate) polyethylene, polypropylene, poly(ethylene glycol), poly(ethylene oxide), poly (ethylene terephthalate), polyvinyl acetate), polyvinyl chloride, polystyrene, polyvinyl pyrrolidone, and polyvinyiphenol. Representative bioerodible polymers include polylactides, polyglycolides and copolymers thereof, poly(ethylene terephthalate), poly(butic acid), poly(valeric acid), poly(lactide-co-caprolactone), poly[lactide-co-glycolide], polyanhydrides, polyorthoesters, blends and copolymers thereof.

More specifically, cellulose acetate phthalate such as CA-398-10NF sold by Eastman Chemical Company may be used as the coating material. Under low pH conditions like those previously described for production of N-chlorosuccinimide, the coating remains stable. However, when the core components are depicted, the higher pH (>6.0) dissolves the coating. The porosity can be controlled by dissolving the cellulose in a solvent, then adding an effective amount of non-solvent. After application of the coating, the solvent and non-solvent are removed via evaporation, leaving behind a membrane with a distinct porosity. The porosity can be further altered in symmetry, number of pores, and size of pores by altering the coating components and processing. For example, a decrease in solvent to polymer (S/P) ratio, an increase in nonsolvent/solvent (N/S) ratio, an increase in nonsolvent/polymer (N/P) ratio in the casting solution composition, and a decrease in the temperature of the casting solution tend to increase the average size of the pores on the surface of resulting membranes. Further, an increase in S/P ratio in the casting solution composition, and an increase in the temperature of the casting solution, tend to increase the effective number of such pores on the membrane surface.

Some applications may benefit from a membrane that provides a long term treatment with antimicrobial agents. After the core is extruded, the membrane coating is formed by either directly applying a film-forming membrane and evaporating off any solvents (including water) and non-solvent in the membrane. Alternatively, after the core is extruded, the phase inversion process may be used to produce long fibrous micro-reactors that can be woven or combined with woven materials.

4) In-Situ Formation of Permeation Channels: Polymeric Component+Hydrophilic Component

The coating material disclosed in this section provides effective environmental protection of the underlying core during processing, formulating, and storage. However, upon exposure to the main solvent, the coating material forms a membrane that controls the permeation rate of the solvent through the membrane, as well as the diffusion rate of the components in the core into the main solvent.

The coating material of the invention includes a polymeric component and a hydrophilic component. The polymeric component can be hydrophilic or hydrophobic depending on the application. Generally, hydrophilic polymers are used when it is desired for the coating to dissipate after the core is depleted. Hydrophobic polymers are used where more integrity is desired in the hydrophilic solvent.

The coating material may be designed to become activated based on one or more environmental criteria such as pH or temperature. For example, cellulose phthalate, which may be used as the hydrophilic component, remains stable under low pH conditions but hydrolyses when the pH rises near or above neutral. Fully hydrolyzed polyvinyl alcohol such as Elvanol® 71-30 sold by E.I. DuPont is virtually insoluble in cold water but soluble in hot water. By selectively choosing the hydrophilic component, the membrane can be formed in-situ based on specific environmental conditions.

Utilizing polysaccharides can induce a delay in allowing the solvent to permeate the composite thereby restraining generation or release of the agents from the substrate. This can be useful in applications such as laundry bleaching where it is desirable to release or produce the bleaching agent after the wash cycle begins to avoid premature release and subsequent localized bleaching of the fabric. Where as incorporating nonionic surfactant allows for rapid exposure of the substrate to the solvent.

Additionally, coagulants such as alum, aluminate, or polyamines can be incorporated into the composite providing both a barrier which exposes the porosity when contacted by the solvent, while enhancing attraction of anionic charged COD to the oxidants being released or generated by the substrate, and enhancing COD removal by coagulation.

4a) Polymeric Component

The polymeric component can be any number of thermoplastics and fiber forming polymers or polymer precursors, including but not limited to polyvinyl chloride, polyacrylonitrile, polycarbonate, polysulfone, cellulose acetates, polyethylene terephthalates, a wide variety of aliphatic and aromatic polyamides, and polysiloxane. Using this coating technology, a membrane with controlled porosity is produced. Representative synthetic polymers include polyphosphazines, polyvinyl alcohols, polyamides, polycarbonates, polyalkylenes, polyacrylamides, polyalkylene glycols, polyalkylene oxides, polyalkylene terephthalates, polyvinyl ethers, polyvinyl esters, polyvinyl halides, polyvinylpyrrolidone, polyglycolides, polysiloxanes, polyurethanes, polyacrylic acids and copolymers thereof. Other suitable polymers include but are not limited to, methyl cellulose, ethyl cellulose, hydroxypropyl cellulose, hydroxypropyl methyl cellulose, hydroxybutyl methyl cellulose, cellulose acetate, cellulose propionate, cellulose acetate butyrate, cellulose acetate phthalate, carboxymethyl cellulose, cellulose triacetate, cellulose sulfate sodium salt, poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate), poly(octadecyl acrylate) polyethylene, polypropylene, poly(ethylene glycol), poly(ethylene oxide), poly (ethylene terephthalate), polyvinyl acetate), polyvinyl chloride, polystyrene, polyvinyl pyrrolidone, and polyvinyiphenol. Representative bioerodible polymers include polylactides, polyglycolides and copolymers thereof, poly(ethylene terephthalate), poly(butic acid), poly(valeric acid), poly(lactide-co-caprolactone), poly[lactide-co-glycolide], polyanhydrides, polyorthoesters, blends and copolymers thereof.

The polymeric component can be selected based on the conditions in which the final composition will be applied. For example, when a hydrophilic polymer is desired for hot water conditions, fully hydrolyzed polyvinyl alcohol such as Elvanol® 71-30 can be used. However, in cold water applications, partially hydrolyzed polyvinyl alcohols such as Elvanol® 52-22 can be substituted when it is desired to have the membrane dissipate after the substrate is depleted.

The polymeric component can be made to possess a cationic charge to attract anionic charged chemical oxygen demand. Incorporating polyamines or components such as chitosan into the polymer matrix that possess a cationic charge can improve the efficiency of oxidation by bring the reactants into close proximity due to ionic attraction.

4b) Hydrophilic Component

The hydrophilic component can be selected from a mineral salt, water soluble silicate, or waxy surfactants.

Examples of polymer used as a hydrophilic polymer component include but are not limited to polyvinyl alcohols, polyethylene glycols, polyoxyethylene fatty acid esters, polyoxyethylene alcohols, poloxamers, polyacrylates, polyacrylamides, polymaleic acids. Cross-linked polyacrylic acid, polysaccharide, or polyoxyethylene polyoxypropylene block copolymer may also be used as the hydrophilic polymer.

Examples of hydrophilic fatty acid salts include sodium, potassium, calcium, magnesium stearate, and other fatty acids having from 10-60 carbons, at least one carboxylic acid function groups having the general formula (COOR), where R is a metal or ester component.

Examples of other inorganic hydrophilic components include magnesium perchlorate and combinations of calcium, magnesium, sodium, lithium, and potassium with chlorides, chlorates, perchlorates, bicarbonates, carbonates, nitrates, sulfates, phosphates, and their various oxygen derivatives (i.e. chloride, chlorite, chlorate, perchlorate etc.). and water soluble silicates such as sodium metasilicate, borosilicate, alkylsilicate. Alkali salts in general may be used as the hydrophilic component.

Additional hydrophilic components include metal salts or oxides of metals such as manganese, iron, copper, titanium, and other transition metals and their various derivatives. Further still, various organic and inorganic acids can be included to later function as a reactant. Acids include sodium bisulfate, pyrosulfate, citric acid, oxalic acid, succinic acid, and the like.

The hydrophilic component should be soluble in the solvent used to dissolve the polymer. Another option is to disperse insoluble particle fines, typically in the range of 0.2-20 microns in size in the solvent. For example, polyvinyl alcohols are hydrophilic polymers such as DuPont Elvanol® 52-22 and will not dissolve in solvents used to dissolve the hydrophilic polymers. However, when dispersed in the viscous polymer gel or solution and applied to a substrate thereby producing a composite coating upon contact with the hydrophilic solvent, the polyvinyl alcohol dissipates, producing a porous membrane.

Where the hydrophilic component is soluble in the main solvent, the coating material on the core produces a micro-porous membrane upon contact with the main solvent. The hydrophilic component dissolves, leaving only the non-soluble structure behind.

Waxy surfactants include but are not limited to: polyethylene glycol, polyoxyethylene alcohol, and polyoxyethylene fatty acid ester.

Anionic surfactant includes a higher fatty acid salt, a higher alcohol sulfate salt, a higher alcohol sulfonate, a sulfated fatty acid salt, a sulfonated fatty acid salt, a phosphate salt, a sulfate salt of a fatty acid ester, a sulfonate salt of a fatty acid ester, a sulfate salt of a higher alcohol ether, a sulfonate salt of a higher alcohol ether, an acetate substituted with a higher alcohol ether, a condensation product of a fatty acid with an amino acid, an alkylolated sulfate salt of a fatty acid amide, an alkylated sulfonate salt of a fatty acid amide, a sulfosuccinate salt, an alkylbenzene sulfonate, an alkylphenol sulfonate, an alkylnaphthalene sulfonate, an alkylbenzimidazole sulfonate, an amidoether carboxylic acid or a salt thereof, an ether carboxylic acid or a salt thereof, N-acyl-N-methyltaurine or a salt thereof, an amidoether sulfuric acid or a salt thereof, an N-acylglutamic acid or a salt thereof, an N-amidoethyl-N-hydroxyethylacetic acid or a salt thereof, an acyloxyethanesulfonic acid or a salt thereof, an N-acyi-p-alanine or a salt thereof, an N-acyl-N-carboxyethyltaurine or a salt thereof, an N-acyl-N-carboxyethylglycine or a salt thereof and an alkyl or alkenyl-aminocarbonylmethylsulfuric acid or a salt thereof. Among them, a higher alcohol sulfate salt is preferable.

Then, the amphoteric surfactant includes an amine oxide such as an alkyldimethylamine oxide and a betaine such as an alkyldimethylamino fatty acid betaine and an alkylcarboxymethylhydroxyethylimidazolium betaine. A betaine is preferable.

The cationic surfactant includes an alkyl trimethyl ammonium salt such as lauryl trimethyl ammonium chloride, stearyl trimethyl ammonium chloride and cetyl trimethyl ammonium chloride; a dialkyl dimethyl ammonium salt such as distearyl dimethyl ammonium chloride and a dialkyl(C.sub.12-C.sub.18) dimethyl ammonium chloride; an alkyl dimethyl benzyl ammonium salt such as an alkyl (C.sub.12-C.sub.14) dimethyl benzyl ammonium chloride; a substituted benzalkonium salt; a mono-cationic compound such as a benzethonium salt and, besides, a poly-cationic compound such as an N-alkyl-N,N,N′,N′,N′-pentamethyl-propylene ammonium salt. Among them, an alkyl trimethyl ammonium salt, a dialkyl dimethyl ammonium salt, an alkyl dimethyl benzyl ammonium salt or a substituted benzalkonium salt is preferable. Lauryl trimethyl ammonium chloride, stearyl trimethyl ammonium chloride, cetyl trimethyl ammonium chloride, distearyl dimethyl ammonium chloride, a dialkyl (C.sub.12-C.sub.18) dimethyl ammonium chloride or an alkyl (C.sub.12-C.sub.14) dimethyl benzyl ammonium chloride is particularly preferable.

To further improve the stability of the formed membrane, an alloy component can be incorporated into the membrane to form an alloyed reactor wall membrane. For example, addition of poly(phenylene oxide dimethyl phosphonate) to cellulose acetate on a 1:1 w/w mixture can increase membrane tolerance from a pH of <8 to a pH of 10-10.7 for extended usage. An alloying compound is typically an organic component that is combined with the primary hydrophobic component that enhances the polymer membrane's chemical and/or thermal stability. The alloying compound can also be a cross-linking agent such as triflic acid with phosphorous pentoxide, trifluoromethansulfonate, glycouril, bifunctional organosilane, etc., or a plasticizer.

In some embodiments, a cross-linking agent that enhances the structural integrity and rigidity with a polymer precursor such as styrene is included in the reactor wall. Styrene, a cross-linking agent such as divinylbenzene, a solvent, and non-solvent are mixed and applied to form an effective film, followed by the step of initiating polymerization by applying a persulfate or activating peroxide solution before removing the solvent and non-solvent by evaporative drying. The persulfate may be applied during the removal of the solvent and non-solvent, in situ. After the drying, a plastic coating layer having a micro- or macro-porous structure with substantially improved rigidity and strength is obtained.

A plasticizer may also be used to increase the pliability as well as alter the hygroscopicity of the membrane coating.

Alloying compounds such as plasticizers and cross-linking agents may be incorporated into the reactor wall to further improve its structural integrity and/or stability across different temperature and pH ranges. The cross-linking agents may be, for example, glycoluril or bifunctional organosilanes. As stated above, the alloying component can also be a cross-linking agent such as triflic acid with phosphorous pentoxide, trifluoromethansulfonate, and the like.

5) Forming the Reactor Wall

The hydrophilic first component and the polymeric second component are combined in a preparation solvent to form a liquid state mixture. In the case where both components are soluble in the preparation solvent, the hydrophilic first component can be dissolved in the preparation solvent separately from the polymeric second component to prepare two separate solutions. The two solutions are then combined and thoroughly mixed to make a homogeneous solution. The homogeneous solution is applied to the core using commonly used coating methods such as spraying the coating on the core in a fluidized dryer, rotary dryer, and the like. Another method is to spray the homogeneous solution on the core or immersing the core in the homogeneous solution, then drying the core in a dryer such as a vacuum dryer, rotary dryer, fluidized dryer, tray dryer, and the like.

Where only one of the components (e.g., the polymeric second component) is soluble in the preparation solvent, the insoluble component is preferably suspended in the preparation solvent as very fine particles (e.g., <20 μg). For example, methylene chloride may be used as the preparation solvent for dissolving cellulose triacetate (a polymeric second component) to produce a viscous medium in which fine particles of metasilicate (a hydrophilic first component) are suspended. After being applied to the core, the polymer sets, holding the metasilicate in place. When contacted with a hydrophilic solvent, the suspended metasilicate particles turn into permeation channels (e.g., by dissolving).

The coating material may be applied to the core in the form of an aerosol, a liquid, an emulsion, a gel, or a foam to form the reactor wall. The preferred form of coating depends on the composition of the coating being applied, the application equipment, and conditions. The coating generally comprises from 0.2 to 5% of the total weight of the micro-reactor. However, the actual amount of membrane coating can vary based on the size of the reactor, porosity, and the like.

The coating material described herein is easy to produce as it requires only a single preparation solvent. This is different from, and usually simpler than, production of a membrane that requires a liquid solvent and liquid non-solvent. The single coating provides a barrier film for environmental protection and allows for in-situ generation of a porous membrane for regulated control of permeation rates through the membrane.

In one aspect, the invention is a method of producing the reactor described above, and also a method of using the reactor to treat an aquatic system. The invention is a method of generating high yields of oxidizers, biocides and/or virucidal agents in-situ by using the reactor that is described above. The reaction in the reactor is triggered when the reactor is exposed to the body of water that is to be treated by the products of the reaction.

The core that is formed as described above is coated with an effective amount of coating material. The “effective amount” of coating takes into consideration the solubility characteristics of the coating under the conditions in the application so as to ensure that the structural integrity of the reactor remains sufficiently intact until such time as the reactants have been depleted. The coating material may be applied by using any effective means of distributing the coating material over the surface of the core, such as spray coating in a fluidized bed, or applying a foam or liquid containing the coating material and mixing. Then, the coated composition is dried by using an effective means of drying, such as a fluidized drier or a tray drier, rotary drier and the like.

Once the core has been produced, the coating is effectively applied in the form of liquid, foam, gel, emulsion and the like. The coating can be applied by aerosol, spray, immersion and the like. The coating may be applied with a mechanical mixing device such as a blender/mixer, then dried using any number of batch or continuous drying techniques such as tray driers, rotary driers, fluidized bed driers, and the like. The preferred technique is to accomplish coating and drying in a continuous fluidized bed drier. The fluidized bed drier can incorporate multiple stages of drying to apply multiple applications of coating, perform different steps in the coating process (i.e., coating, polymerization, evaporation) and the like under continuous or batch processing. Generally, the product temperature during the coating process should not exceed 100° C. and preferably 70° C. During membrane coating, the application of the coating should occur at <50° C. and preferably <30° C. depending on the solvent and non-solvent that are used.

The order of application, evaporation, drying, etc. of the coating material varies based on the types of polymers, solvents, non-solvents and techniques used to produce the porous membrane. For example, a cellulose acetate membrane is effectively applied by first dissolving the cellulose polymer in a solvent, then adding a non-solvent such as water and magnesium perchlorate to produce the gel. The gel is coated on the core by spraying or otherwise applying a thin film of gel onto the surface of the core, then evaporating the solvent and the volatile components of the non-solvent.

A polyamide membrane can be produced by using the method that is commonly referred to as the “phase inversion process.” The phase inversion process includes dissolving a polyamide in a solvent such as dimethyl sulfoxide to form a gel, applying the gel to form a thin film, then applying the non-solvent to coagulate the polymer. Then, the solvent and non-solvent are evaporated.

### EXPERIMENTAL DATA

1) Test 1

A 500 ml sample of distilled water was treated with 0.5 grams of 4.8% A.O. potassium monopersulfate (PMPS) and 1.3 grams of N-succinimide. The solution pH was increased to pH 10.13 using K₂CO₃. Immediately, 0.5 grams of NaCl was added and the solution was vigorously mixed using a magnetic stirrer for 5-minutes. A 25 ml sample was removed and 3 ml of 0.1-molar EDTA solution was added to neutralize any residual PMPS. The solution pH was 8.2 when DPD reagent was immediately added, producing a faint pink color.

The solution was titrated with a thiosulfate solution whereby 0.6 ppm of chlorine based oxidizer was detected. The result of Test 1 illustrated that producing hypohalites and subsequent haloimides in alkaline conditions does not have any significant advantages or benefits.

2) Test 2

A 500 ml sample of distilled water was treated with 0.5 grams 4.8% A.O. potassium monopersulfate (PMPS), 1.0 grams succinic acid, and 1.3 grams of N-succinimide. The solution pH was measured at pH 3.65. 0.5 grams of NaCl was added, and the solution was vigorously mixed using a magnetic stirrer for 5-minutes. During the reaction period, no chlorine odor was detected. A 25 ml sample was removed and 3 ml of 0.1-molar EDTA solution was added to neutralize any residual PMPS. The DPD reagent was added producing a bright pink color.

The solution was titrated with thiosulfate solution whereby 20.4 ppm of chlorine based oxidizer was detected. The results of Test 2 shows that the same concentrations of reactants under acid conditions efficiently generated 20.4 ppm of N-chlorosuccinimide and/or hypohalite. The lack of chlorine odor and bleaching of the DPD reagent indicates the predominant components was stabilized chlorine in the form of N-chlorosuccinimide.

3) Test 3

A N-chlorosuccinimide generating micro-reactor was produced by combining: 15.15 wt % PMPS, 15.15 wt % NaCl, 30.30 wt % succinic acid, and 39.39 wt % N-succinimide. The combination was placed in a grinder until they formed a fine dusty powder. A solution of 95% ethanol and 5% isopropyl alcohol was treated with 1% Carbopol® to produce a thick gel. 10 grams of gel was added to 100 grams of the fine powder and slowly mixed until the components agglomerated into granules. The granules where transferred to a fluidized drier, whereby they where fluidized while sustaining an exit air temperature of about 65° C. A solution of 30 wt % metasilicate was applied by supplying an aerosol spray into the fluidized stream of granules. A coating made up approximately 2.5 wt % of the total. The granules where allowed to continue drying until the water had been sufficiently removed.

A 500 ml of DI water was treated with K₂CO₃ to raise the pH to 10.58. 3.64 grams of the stated micro-reactors was added to the solution and vigorously mixed for 7 minutes. Periodically the solution was checked to see if the core of the reactor had dissolved, and a solution of dissolved K₂CO₃ was added to sustain the pH>10.0. It took approximately 5 minutes to dissolve substantially all of the core of the reactors. An additional 2 minutes of mixing was provided.

A 25 ml sample was removed and 3 ml of 0.1-molar EDTA solution was added to neutralize any residual PMPS. The DPD reagent was immediately added producing a bright pink color. The solution was titrated with thiosulfate solution whereby 12.8 ppm of chlorine based oxidizer was detected. The results of Test 3 show that even when the bulk water conditions do not favor generation of N-chlorosuccinimide and hypohalites, the reactor of the invention provided a condition that achieved a 63% conversion.

By further regulating diffusion rates utilizing micro-porous membrane coatings and/or multiple coatings, rather than the macro-porous coating like that achieve with silicate, still higher conversions are to be expected.

4) Test 4

Granules capable of generating chlorine dioxide were produced by first coating sodium chlorite with 2.5 wt. % polyvinyl alcohol (PVA). 40 wt. % of this PVA-coated chlorite was combined with 20 wt. % of dichloroisocyanuric acid and 40 wt. % of sodium bisulfate, mixed and pressed into tablets using a pneumatic press with an aluminum die to produce 50-gram tablets. The tablets were broken and granules were recovered in 100-micron increments ranging from 300-800 microns. 2-40 gram samples of granules ranging from 300-400 microns were collected. Two grams of the same sample range was removed for later testing.

One 40-gram sample of the granules was coated with a composite comprised of cellulose triacetate and magnesium perchlorate. The composite coating was produced by dissolving 5.35 grams cellulose triacetate into 700 grams methylene chloride to produce a polymer solution. One gram of magnesium perchlorate was dissolved in 20 grams of ethanol, then added to the polymer solution. Forty grams of granules were added to a fluidized drier, then fluidized while an atomized spray of the composite coating solution was applied at approximately 30° C. until 10 wt. % of coating (based on polymer weight) was applied.

0.5 grams of uncoated granules were added to 500 grams of water while sustaining vigorous mixing to prepare a solution sample. After 10 minutes, 25 mL of the solution sample was added to a sample cell for a spectrophotometer. The sample was measured for chlorine dioxide using standard spectrophotometer absorbance at 445 nm wavelength. Two samples were thus prepared, and the results were 33 ppm and 35 ppm, making the average chlorine dioxide concentration 34 ppm.

For comparison, 0.5 grams of coated granules was added to 500 grams of water while vigorously mixed. Reaction was allowed to proceed for 10 minutes. 25 mL samples were placed in a sample cell and the chlorine dioxide value was measured. With two samples thus prepared, the chlorine dioxide concentrations were 123 ppm and 127 ppm, averaging to 125 ppm.

While the uncoated granules generated 20% of the potential chlorine dioxide of the granules, the composite coating increased the chlorine dioxide yield to almost 88%. This is a >400% increase in conversion to chlorine dioxide.

5) Test 5

The following series of tests were performed to compare the generated yields of Test 4 to the maximum achievable yield of the composition.

A maximum achievable yield for each sample was determined by first measuring 500 grams of water and 0.5 grams of uncoated granules. To prepare the solution sample, 15 grams of the water was added to a 25-mL reactor with a magnetic stirring rod. The 0.5 grams of uncoated granules were added while under vigorous mixing, and a lid was placed on top. The water-granule combination was mixed for 60 seconds whereby it was then immersed in the remaining beaker of water (the remaining 485 grams), the lid was removed, and the content was released into the bulk sample of water. The combined sample was allowed to mix until a total of 10-minutes lapsed. Two samples were thus prepared, and the chlorine dioxide concentrations in the samples were 166 ppm and 171 ppm, making the average chlorine dioxide concentration 168.5 ppm.

For comparison, chlorine dioxide concentrations were measured for coated granules produced by the procedure of Test 4 including the addition of granules to the fluidized drier. A sample of the granules was first crushed to compromise the coating, then added to 15 grams of water in a 25-mL reactor while being stirred with a mixing rod. The granules were reacted for 60 seconds, then immersed in the remaining 485-gram sample of water. The lid was removed and the contents were released into the bulk of the water sample. A total of 10 minutes was allowed to complete the reaction. Between two similarly prepared samples, the resulting chlorine dioxide concentrations were 141 ppm and 144 ppm, averaging to 142.5 ppm.

In these tests, there are less reactants per weight of the coated samples than per weigh tof the uncoated samples, since the coating itself has a weight. While these tests illustrate that the coated samples produced less chlorine dioxide on a per sample-weight basis, the conversion percentage is higher for the coated samples than for the uncoated samples. When the uncoated granules were added to 500 mL of water, they produced 34 ppm of the 168.5 ppm available, while the same test with the coated granules produced 125 ppm of the available 142.5 ppm. The conversion percentage of the uncoated granules is only 20% of the maximum achievable yield, 88% of the maximum achievable yield was converted to chlorine dioxide for the coated granules. Overall, the coated granules yielded 367% more chlorine dioxide than the uncoated granules. It can be concluded from these results that the coating material increase the chlorine dioxide yield under conditions that are not conducive to produce chlorine dioxide, the target product.

6) Test 6

A composite comprised of 5.35 grams cellulose triacetate and 0.2 grams of magnesium perchlorate was prepared as in Test 4. The 0.2 grams of magnesium perchlorate was dissolved in 4 grams of ethanol, then added to the polymer solution and mixed. The resulting coating solution was applied to forty grams of granules in a fluidized drier using an atomized spray at approximately 30° C. until a total of 5 wt. % (based on polymer weight) was applied.

In the first group, a 0.5-gram sample of the coated granules thus prepared was crushed and placed in 15 grams of water in a 25-mL reactor with a lid and a stirring rod. After 60 seconds of reaction time, the sample was immersed in the remaining sample of water and released to provide a total of 500 grams of water and 0.5 grams of coated granules. The procedure was repeated with two samples, and the chlorine dioxide concentrations with the two samples were 155 ppm and 159 ppm. The average chlorine dioxide concentration is 157 ppm.

In the second group, a 0.5-gram sample of the coated granules was added to 500 grams of water with vigorous mixing. After 10 minutes, the sample was analyzed. This procedure was repeated with two samples, the end chlorine dioxide concentrations of which were 148 ppm and 152 ppm, averaging to 150 ppm.

Comparison of the two groups illustrates that reducing the porosity of the composite restricts diffusion of the core components. Dividing the average of the second group by the average of the first group, the conversion of the reactants to chlorine dioxide is 95.5%.

7) Test 7

50 grams of potassium monopersulfate was added to a fluidized drier. A solution was prepared by combining 5 wt. % PVA (e.g., Elvanol® 52-22 made available by DuPont) and 1.3 wt. % sodium metasilicate with the remainder of the water, thereby making a total of 500 grams of solution. The solution was applied with an outlet temperature of approximately 70° C. until a 5 wt. % of coating based on total solids was applied.

A sample ranging in size from 300-400 micron of coated monopersulfate (MPS) was added to a sample tray filled with water. A 20× magnification glass was used to identify when the first signs of bubbles were observed, and when the granules were depleted.

It took 42 seconds before a reaction (i.e., bubbles) was observed. The granules required over 10 minutes to deplete all of the observable MPS.

8) Test 8

Two samples of chlorine dioxide generating reactors remaining from Test 4, one un-coated and one coated, were exposed to ambient air conditions for 48 hours. The uncoated granules were yellow and emitted a strong chlorine odor, while the coated sample had no change in color or distinguishable odor.

This Test illustrates that composite coating can be effectively used to increase the yield of in-situ generated oxidants when the reactants are effectively coated with the composite. The yield or percent conversion can be controlled by altering the composite composition to control the rate of permeation. Furthermore, the composite can be designed to induce a delay in release of the oxidant or in-situ generated oxidant. This can be extremely beneficial in applications such as laundry bleaching where it is desired to release the oxidant during the wash cycle to prevent localized bleaching of color and fabric. Further, the composite can contain a reactant such as a catalyst for generation of hydroxyl radicals, or an acid for generation of chlorine dioxide. The composite coating can also effectively provide environmental protection by acting as a barrier film.

9) Results of Comparative Experiments

FIG. 4 shows the stability of potassium monopersulfate in various alcohols which can be used to form suspensions or binders in the core. As stated above, alcohols may be used to aggregate PMPS into the core, for example when the core is of the homogeneous configuration. The alcohol may be formed into a gel or converted into an almost-solid form by adding rheology modifiers like Carbopol®. FIG. 4 graphically summarizes the active oxygen (A.O. %) level in compositions prepared with different alcohols as a function of time (days in storage). The control group did not include any alcohol, and showed a drop in the active oxygen level after 14 days, from 4.41% to 4.4%. In contrast, PMPS stored in isopropyl alcohol (IPA) and ethyl alcohol (EA) showed an increase in the active oxygen level. The PMPS stored with methyl alcohol (MA) showed a significant drop in the active oxygen level in the first week of storage, but then recovered during the second week to match the overall active oxygen level drop of the control group. Although there was alcohol in the tested compositions, their core is substantially free of moisture. FIG. 4 suggests that a core made using EA or IPA may be most effective for stabilizing PMPS.

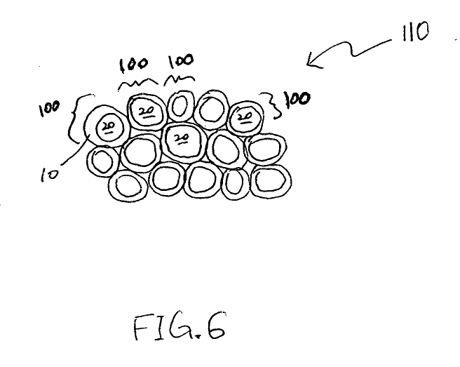

FIG. 5 shows the increase in viscosity provided by Carbopol® used to alter the rheology of the solution. More specifically, the plot of FIG. 5 shows viscosity as a function of Carbopol® resin concentration in water. As shown, the viscosity of a medium (e.g., alcoholic gel) can be increased and controlled by adjusting the Carbopol concentration.

FIG. 6 demonstrates that a plurality of compositions 100 (e.g., see FIG. 2A) may be agglomerated to form an agglomerate composition 110. Any embodiment of the composition 100 that is mentioned above may be agglomerated with a binder to form a larger agglomerate composition 110. If desired, different embodiments of the composition 100 may be mixed in one agglomerate composition 110. An agglomerate composition 110 may, however, include a plurality of the same type of composition 100.

To form the agglomerate composition 110, the compositions 100, prepared as described above, are fed into an agglomerating equipment. Inside the equipment, a pressure of about 1,000 to about 10,000 psig is applied to the composition 100. The exact pressure to be applied is chosen based on the desired density of the resulting agglomerate composition 110, which affects how fast the agglomerate composition 110 dissolves and releases the oxidizer. Sometimes, depending on the desired density of the agglomerate composition 110 and the make up of the composition 100 that is used, a binder may not be necessary. Any commercially available compactor or agglomerator, and generally machines for roll compaction, briquetting/tableting, and the like, may be used for the aggregation of reactors. Hosokawa Micron Corporation offers equipment that are suitable for forming the agglomerate composition.

In some embodiments, the composition 100 may be mixed with binders or fillers prior to being fed into the aggregating equipment. A binder helps the separate pieces of composition 100 stay together, and a filler makes the agglomerate composition more solid by filling in the gaps between oxidizer tablets. The fillers may also provide added benefits such as pH buffering and coagulation. The binders and the fillers help control the release rate of the oxidizer when the agglomerate composition is placed in a predetermined solvent. They may also provide additional benefits such as pH buffering and coagulation. Some exemplary materials that may be used as binders and fillers include mineral salts, clays, zeolites, silica, silicates, polyaluminum chloride, aluminum sulfate, polysaccharide, and polyacrylamide. The mineral salts, more specifically, may be a chloride, carbonate, bicarbonate, hydroxide, sulfate, or oxide of calcium, magnesium, sodium, lithium, potassium. Suitable binder materials include glycoluril, mineral salts, clays, zeolites, silica, or silicates. The binder material affects the rate at which the agglomerate composition dissolves and releases the oxidizer. Spray towers, mixer/densifiers, fluidized agglomeration equipment (e.g., Precision Granulation equipment sold by Niro Inc.) may be used in the aggregation process.

The resulting high density agglomerate composition can be crushed or ground to produce cores having a specific particle size.

The reactor has far-reaching applications. Reactants such as PMPS and NaCl are quite stable when dry but once moisture is added and reactions are triggered, an agent with a completely different set of properties may be produced. The reactor allows for a stable point-of-use product with easy application. The fact that the reaction is triggered by moisture allows for a wide range of applications since the reactor remains stable until some type of liquid, such as water or urine, contacts the composition. The contaminated liquid that is to be treated is what activates the reactor to generate and release target agents for treatment. When the released target agents are oxidizers, they treat the bulk liquid by controlling bacteria, viruses and various organic and inorganic contaminants.

The benefits of the invention are broad in nature. The reactors, or the micro-reactors, provide storage stable, and safe to use bleaching agents and antimicrobial agents in a ready to use form. This technology greatly enhances the utility of the agents. For example, the agents can be combined with laundry detergents and provide one or multiple bleaching agents to provide a synergistic effect from a single or multiple reactors in the formulation. The micro-reactors can be impregnated into wipes whereupon contact with moisture, release powerful anti-microbial agents. Further still, the micro-reactors can be combined with other additives to provide for anti-microbial capabilities such as animal storage, feed, and cleaning facilities. Further still, the micro-reactors provide for convenient generation of anti-microbial agents for use in home and institutional applications as cleansers or diluted with water as a spray or aerosol. The micro-reactors also allow for applications where the products are suspended in a gel for easy application such as in medical or cleaning applications. Yet still, micro-reactors can generate multiple agents from one reactor, or be combined with multiple reactors each generating its own agent(s) to provide a combined effect to the bleaching or antimicrobial application.

One benefit of the invention is to control the reactor chemistry as to maximize the concentration of reactants in an environment conducive to forming the target agents. For example, N-chlorosuccinimide generation is best performed under acidic conditions where chlorine gas and/or hypochlorous acid are readily available. In applications such as laundry bleaching, generation of N-chlorosuccinimide is less than optimal because the alkaline pH (generally >9.0) is not well suited nor producing N-chlorosuccinimide. By producing N-chlorosuccinimide in a contained space inside the reactor and controlling the diffusion rate of product and reactants out of the reactor, the conditions that are conducive to high conversion rates and yields are sustained. Thus, the yield is maximized prior to the product's being releasing into the alkaline bleaching environment of the wash-water. Similar characteristics are true of the various oxidizers produced by reacting reagents to generate more powerful oxidants in-situ. Conditions such as pH, concentrations of reactants, and minimizing oxidizer demand such as that found in the bulk wash-water must be controlled to maximize conversion of the reactants and the yield of the target agent. Utilizing granules of oxidizers incorporating precursors that require acid catalyzed reactions into alkaline wash water and high demand deplete in-situ efficacy.

The above description of the coating materials is not intended to limit the invention. In other chemical applications, such as where solvents are organic, a suitable coating may be selected to accomplish the desired effect while providing sufficient resistance to decomposition or dissipation prior to carrying out the function of a reactor. While the foregoing has been with reference to a particular embodiment of the invention, it will be appreciated by those skilled in the art that changes in this embodiment may be made without departing from the principles and spirit of the invention.

What is claimed is:

1. A composition for controlling a release rate of an agent, the composition comprising:
a hydrophilic first component; and
a polymeric second component mixed with the hydrophilic first component;
wherein the composition remains substantially impermeable until exposure to a hydrophilic solvent that converts sites in the composition that are occupied by the hydrophilic first component to permeation channels for the hydrophilic solvent.

2. The composition of claim 1, wherein the polymeric second component is a hydrophobic substance that is insoluble in the hydrophilic solvent.

3. The composition of claim 1, wherein the polymeric second component is a hydrophilic polymer that has a lower solubility in the hydrophilic solvent than the hydrophilic first component.

4. The composition of claim 3, wherein the hydrophilic polymer is polyvinyl alcohol.

5. The composition of claim 1, wherein the hydrophilic solvent is water and the hydrophilic first component is a water-soluble silicate.

6. The composition of claim 1, wherein the hydrophilic solvent is water and the hydrophilic first component is a water-soluble waxy surfactant.

7. The composition of claim 1, wherein the hydrophilic solvent is water and the hydrophilic first component is a water-soluble polysaccharide.

8. The composition of claim 1, wherein the hydrophilic solvent is water and the hydrophilic first component is a water-soluble mineral salt.

9. The composition of claim 1, wherein the hydrophilic first component is a polyethylene glycol.

10. The composition of claim 1, wherein the hydrophilic first component experiences solvent extraction upon exposure to the hydrophilic solvent.

11. The composition of claim 1, wherein the hydrophilic first component forms a colloidal gel upon exposure to the hydrophilic solvent.

12. A composition for releasing an agent at a controlled rate, the composition comprising:
a core containing an agent; and
a coating material deposited on the core, the coating material having a hydrophilic first component and a polymeric second component and forming a barrier film for shielding the core from environmental elements, and wherein the hydrophilic first component forms permeation channels upon exposure to a hydrophilic solvent, the permeation channels allowing the hydrophilic solvent to reach the core.

13. The composition of claim 12, wherein the hydrophilic solvent reaches the core and dissolves the agent.

14. The composition of claim 12, wherein the polymeric second component is a hydrophobic substance that is insoluble in the hydrophilic solvent.

15. The composition of claim 12, wherein the polymeric second component is a hydrophilic polymer that dissolves in the hydrophilic solvent after substantially all of the agent is dissolved in the hydrophilic solvent.

16. The composition of claim 15, wherein the hydrophilic polymer is a cross-linked polyacrylic acid.

17. The composition of claim 12 further comprising a viscosity modifier in the core, wherein the viscosity modifier is one or more of: cross-linked polyacrylic acid, copolymers, and polysaccharides.

18. The composition of claim 15, wherein the hydrophilic polymer is polyvinyl alcohol.

19. The composition of claim 12, wherein the hydrophilic solvent is water and the hydrophilic first component is a water-soluble silicate.

20. The composition of claim 12, wherein the hydrophilic solvent is water and the hydrophilic component is an alkali salt.

21. The composition of claim 12, wherein the hydrophilic solvent is water and the hydrophilic first component is a water-soluble waxy surfactant.

22. The composition of claim 12, wherein the hydrophilic solvent is water and the hydrophilic first component is a water-soluble polysaccharide.

23. The composition of claim 12, wherein the hydrophilic solvent is water and the hydrophilic first component is a water-soluble mineral salt.

24. The composition of claim 12, wherein the hydrophilic first component is a polyethylene glycol.

25. The composition of claim 12, wherein the hydrophilic first component is magnesium perchlorate.

26. The composition of claim 12, wherein the hydrophilic first component is a fatty acid salt having from 10-60 carbons and at least one carboxylic acid functional group.

27. The composition of claim 12, wherein the hydrophilic first component is a polymer selected from the group consisting of: polyvinyl alcohol, polyethylene glycol, polyoxyethylene fatty acid ester, polyoxyethylene alcohol, poloxamer, polyacrylate, polyacrylamide, and polymaleic acid.

28. The composition of claim 12, wherein the hydrophilic first component is a hydrophilic fatty acid salt selected from the group consisting of: sodium, potassium, calcium, and magnesium stearate.

29. The composition of claim 12, wherein the hydrophilic first component is an inorganic component selected from a group consisting of: magnesium perchlorate, calcium, magnesium, sodium, lithium, potassium, chlorides, perchlorates, bicarbonates, carbonates, nitrates, sulfates, and water soluble silicates such as sodium metasilicate, and borosilicate.

30. The composition of claim 12, wherein the hydrophilic first component experiences solvent extraction upon exposure to the hydrophilic solvent.

31. The composition of claim 12, wherein the hydrophilic first component forms a colloidal gel upon exposure to the hydrophilic solvent.

32. The composition of claim 12, wherein the hydrophilic first component dissolves in the hydrophilic solvent to form permeation channels that are openings of a size of between about 2 nm and about 5 μm.

33. The composition of claim 12, wherein the agent is released from the composition through the permeation channels after dissolving in the hydrophilic solvent.

34. The composition of claim 12, wherein the agent is a reactant that goes through a chemical reaction after dissolving in the hydrophilic solvent to generate a target agent, and wherein the target agent is released from the composition via the permeation channels.

35. The composition of claim 34, wherein the target agent is one of: chorine dioxide, dioxirane, hydroxyl radicals, peracid, singlet oxygen, hypo-halite, and N-halo-amide.

36. The composition of claim 34, wherein the agent is a first reactant, the core further comprising a second reactant that reacts with the first reactant to produce the target agent upon dissolving in the hydrophilic solvent.

37. The composition of claim 12, wherein the agent is an oxidizing agent.

38. The composition of claim 37, wherein the oxidizing agent is one of a peroxygen donor and a free halogen donor.

39. The composition of claim 12, wherein the core contains one or more of a chlorite, a chlorate, a peroxygen donor, an inorganic acid, and organic acid, and a free halogen donor.

40. A method of producing a composition for in-situ generation of a porous membrane, the method comprising:
combining a hydrophilic first component, a preparation solvent, and a polymeric second component to prepare a liquid state mixture;
applying the mixture to a substrate; and
evaporating the solvent to produce a barrier coating on the substrate.

41. The method of claim 40 further comprising preparing the substrate by agglomerating an agent.

42. The method of claim 40 further comprising selecting the hydrophilic first component to be a substance that is insoluble in the preparation solvent.

43. The method of claim 40 further comprising selecting the hydrophilic first component to be soluble in a predetermined main solvent.

44. The method of claim 40, wherein the hydrophilic first component is a polymer.

45. The method of claim 40, wherein the hydrophilic first component is a mineral salt.

46. The method of claim 40, wherein the hydrophilic first component is magnesium perchlorate.

47. The method of claim 40, wherein the hydrophilic first component is polysaccharide.

48. The method of claim 40, wherein the hydrophilic first component is a surfactant.

49. The method of claim 40, wherein the hydrophilic first component is a fatty acid salt having from 10-60 carbons and at least one carboxylic acid functional group.

50. The method of claim 40, wherein the hydrophilic first component is a polymer selected from the group consisting of: polyvinyl alcohol, polyethylene glycol, polyoxyethylene fatty acid ester, polyoxyethylene alcohol, poloxamer, cross-linked polyacrylic acid, polyacrylate, polyacrylamide, and polymaleic acid.

51. The method of claim 40, wherein the hydrophilic first component is a fatty acid salt selected from the group consisting of: sodium, potassium, calcium, and magnesium stearate.

52. The method of claim 40, wherein the hydrophilic first component is an inorganic component selected from a group consisting of: magnesium perchlorate, calcium, magnesium, sodium, lithium, potassium, chlorides, perchlorates, bicarbonates, carbonates, nitrates, sulfates, and water soluble silicates such as sodium metasilicate, and borosilicate.
